(19) United States
(12) Patent Application Publication
(10) Pub. No.: US 2025/0356705 A1
(43) Pub. Date: Nov. 20, 2025

(54) DIGITAL IDENTIFICATION-BASED SYSTEMS AND METHODS

(71) Applicant: PassiveBolt, Inc., Ann Arbor, MI (US)

(72) Inventors: Kabir Zachary Maiga, Canton, MI (US); Philip Michael Johnson, Ann Arbor, MI (US); Simon Forster, Ann Arbor, MI (US)

(21) Appl. No.: 19/282,899

(22) Filed: Jul. 28, 2025

Related U.S. Application Data
(63) Continuation-in-part of application No. PCT/US2024/013348, filed on Jan. 29, 2024.
(60) Provisional application No. 63/482,020, filed on Jan. 27, 2023.
(60) Provisional application No. 63/781,085, filed on Mar. 31, 2025.
(60) Provisional application No. 63/839,911, filed on Jul. 7, 2025.
(60) Provisional application No. 63/841,658, filed on Jul. 10, 2025.

(51) Int. Cl. G07C 9/00

(52) U.S. Cl. CPC G07C 9/00309; G07C 2009/00412

(57) ABSTRACT

An electronic key system is configured to provide an electronic key for physical space. The electronic key system includes a transaction terminal and an operator computing system communication with the transaction terminal. The transaction terminal is configured to communicate with a personal computing device of a user to which access rights are to be issued. The transaction terminal sends requests to the personal computing device for information from a digital identification of a user and for consent of the user to send an access credential thereto. The operator computing system validates the information of the digital identification with a public key of the issuer of the digital identification.

### CROSS-REFERENCE TO RELATED APPLICATION(S)

This application claims priority to and the benefit of U.S. Patent Application No. 63/841,658, filed Jul. 10, 2025, and having the title DIGITAL IDENTIFICATION-BASED SYSTEMS AND METHODS, U.S. Patent Application No. 63/839,911, filed Jul. 7, 2025, and having the title DIGITAL IDENTIFICATION-BASED SYSTEMS AND METHODS, and U.S. Patent Application No. 63/781,085, filed Mar. 31, 2025, and having the title DIGITAL IDENTIFICATION-BASED ACCESS CONTROL SYSTEMS AND METHODS, and is a continuation-in-part of PCT Patent Application No. PCT/US2024/013348, filed Jan. 29, 2024, and having the title DECENTRALIZED IDENTITY-BASED ACCESS CONTROL SYSTEMS AND METHODS, which claims priority to and the benefit of U.S. Patent Application No. 63/482,020, filed Jan. 27, 2023, and having the title ELECTRONIC KEY SYSTEM FOR PHYSICAL SPACES, the entire disclosures of which are incorporated by reference herein.

### TECHNICAL FIELD

This disclosure relates to access control to physical spaces and, in particular, systems and devices using electronic access keys and digital signatures.

### BACKGROUND

Smart locks and other electronic access control devices utilize credentials or various forms of electronic access keys to permit presenters access to physical spaces. However, such systems typically require those parties controlling the electronic access devices and/or issuing the electronic access keys to store personal identifying information of the presenters.

### SUMMARY

Disclosed herein are implementations of electronic access key systems, access devices thereof, and methods therefor. In an implementation, an electronic key system is configured to provide an electronic key for physical space. The electronic key system includes a transaction terminal and an operator computing system communication with the transaction terminal. The transaction terminal is configured to communicate with a personal computing device of a user to which access rights are to be issued. The transaction terminal sends requests to the personal computing device for information from a digital identification of a user and for consent of the user to send an access credential thereto. The operator computing system validates the information of the digital identification with a public key of the issuer of the digital identification.

In an implementation, a transaction terminal for an electronic key system for physical assets includes a controller and a communications interface configured to communicate with a personal computing device via near field communication, Bluetooth, or both and with an asset operator computing system with a wired or wireless network. The transaction terminal is configured to send requests to the personal computing system for information of a digital identification of the user and consents for sending access credentials thereto. The transaction terminal is configured to send the information of the digital identity of the user to the asset operator computing system for validation with a public key of the issuer of the digital identification.

In an implementation, a method is for providing an electronic key for a physical space. The method includes: receiving a physical presentation by a user of a personal computing device to a transaction terminal of an operator computing system of an operator of a physical asset; verifying, with the personal computing device, the identity of the user with biometric information; receiving, with the transaction terminal from the personal computing device, identification information of a digital identification of a user and another credential of the user; validating, with the operator computing system, the identification information and the other credential; and sending, upon validating the identification information and the other credential, an electronic key with the transaction terminal directly to the personal computing device of the user, the electronic key being presentable by the user with the personal computing device to gain access to the physical asset.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic view of an electronic access key system.

FIG. 2 is a schematic view of a party computing system of the electronic access key system.

FIG. 3 is a schematic view of an example hardware configuration of a controller of the party computing system.

FIG. 4 is a schematic view of an access device.

FIG. 5 is an operational diagram of the electronic access key system.

FIG. 6 is a schematic view of the information set of a digital identity of a party.

FIG. 7 is a schematic view of the information set of an electronic access key.

FIG. 8 is a flowchart of a method for operating the electronic access key system to provide or deny access to presenters.

FIG. 9 is a flowchart of a submethod of the method of FIG. 8 for generating digital identities for parties.

FIG. 10 is a flowchart of a submethod of the method of FIG. 8 for setting up and updating access devices.

FIG. 11 is a flowchart of a submethod of the method of FIG. 8 for issuing electronic access keys.

FIG. 12 is a flowchart of a submethod of the method of FIG. 8 for presenting electronic access keys to the access devices.

FIG. 13 is a flowchart of a submethod of the method of FIG. 8 for verifying the electronic access key, the presenter, and the access rights thereof.

FIG. 14 is a schematic of an electronic access key system utilizing digital identifications.

FIG. 15A is a schematic of a digital identification.

FIG. 15B is a schematic of a user profile.

FIG. 16 is a flowchart of a method for issuing digital identifications, issuing access rights, and granting physical access.

FIG. 17 is a flowchart of a submethod of the method of FIG. 16 for issuing digital identifications.

FIG. 18 is a flowchart of a submethod of the method of FIG. 16 for issuing access rights.

FIG. 19 is a flowchart of a submethod of the method of FIG. 16 for granting physical access to a physical asset

FIG. 20 is a flowchart of a method for generating a unique user identifier for a person from a digital identification thereof.

FIG. 21 is a schematic view of an electronic key system according to an embodiment.

FIG. 22A is a schematic view of hardware configuration of a transaction terminal of the operator computing system.

FIG. 22B is a schematic view of hardware configuration of a transaction terminal of the operator computing system configured as a kiosk.

FIG. 23 is a schematic view of a module configuration of the transaction terminal of FIG. 22.

FIG. 24 is a schematic view of a module configuration of a local and/or remote operator computing system of the electronic key system of FIG. 21.

FIG. 25 is a schematic view of operational and information flow of the electronic key system of FIG. 21.

FIG. 26 is a method of a flow diagram of provisioning an electronic key for a physical space.

### DETAILED DESCRIPTION

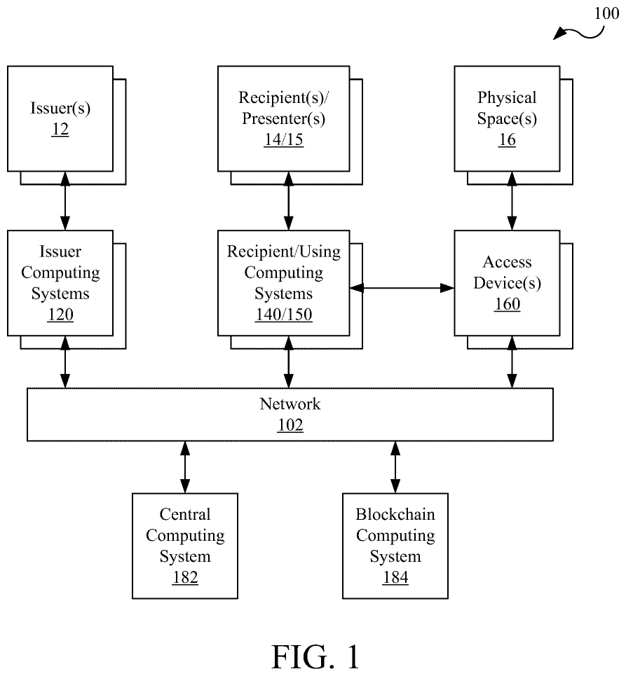

Referring to FIG. 1, an electronic access key system 100 is configured for issuers 12 to issue electronic access keys to recipients 14 to gain access to physical spaces 16 controlled by the issuers 12. The electronic access key system 100 and variations thereof may also be referred to as a decentralized identity-based access control systems, and the methods performed therewith may also be referred to as the decentralized identity-based access control methods. As discussed in further detail below, the electronic access key system 100 utilizes a blockchain and digital signatures to verify that the electronic access keys are untampered and issued by the issuer 12 and/or the presenters 15 presenting the electronic access key are the recipients 14 of the electronic access key. The electronic access key system further assesses the validity of the access rights (e.g., access rights have not been revoked and match the recipient 14, the space 16, and/or the current time). The space 16 is a physical space, such as a room or set of rooms within a building.

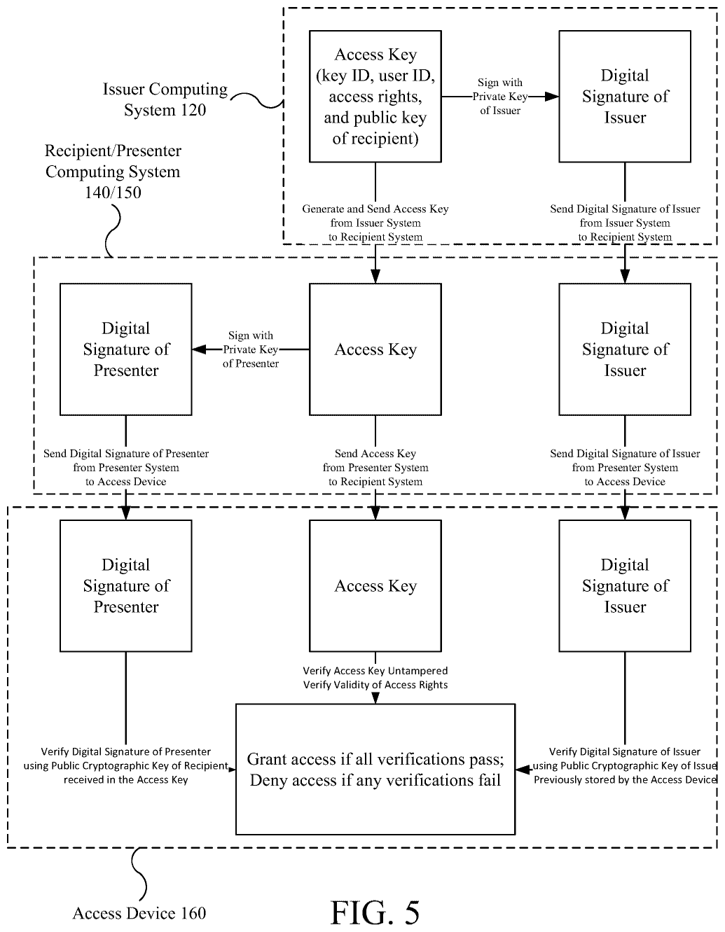

The issuers 12 are those parties that issue the electronic access keys to the recipients 14. The electronic access keys may also be referred to as an attestation or an access attestation. The recipients 14 are those parties to which the electronic access keys are issued by the issuers 12. Presenters 15 are those parties seeking access to the spaces 16 by electronically presenting the electronic access keys. If the electronic access key is determined to be valid and the presenter 15 determined to be the recipient 14 of the electronic access key, the presenter 15 is granted access to the space 16. The issuers 12, the recipients 14, and the presenters 15 may be persons or organizations (e.g., legal entities or other groups of persons). The issuers 12, the recipients 14, and the presenters 15 may be more generally referred to as parties. Furthermore, it should be understood that parties may have the role of the issuer 12, the recipient 14, and the presenter 15 in different contexts. For example, the presenter 15 may be the recipient 14 of the electronic access key that is valid and, when verified as such, be granted access to the space 16. Thus, in FIGS. 1 and 5, the recipient 14, the presenter 15, and their respective computing systems are depicted as common blocks.

Still referring to FIG. 1, the electronic access key system 100 generally includes party computing systems 110 associated with the issuers 12 and the recipients 14, access devices 160 associated with the physical spaces 16 and the issuers 12, one or more central computing systems 182, and a blockchain computing system 184, which are in communication with each other directly or via a network 102 (e.g., the cloud). The party computing systems 110 associated with the issuers 12, the recipients 14, and the presenters 15 may be more specifically referred to as issuer computing systems 120, recipient computing systems 140, and presenter computing systems 150.

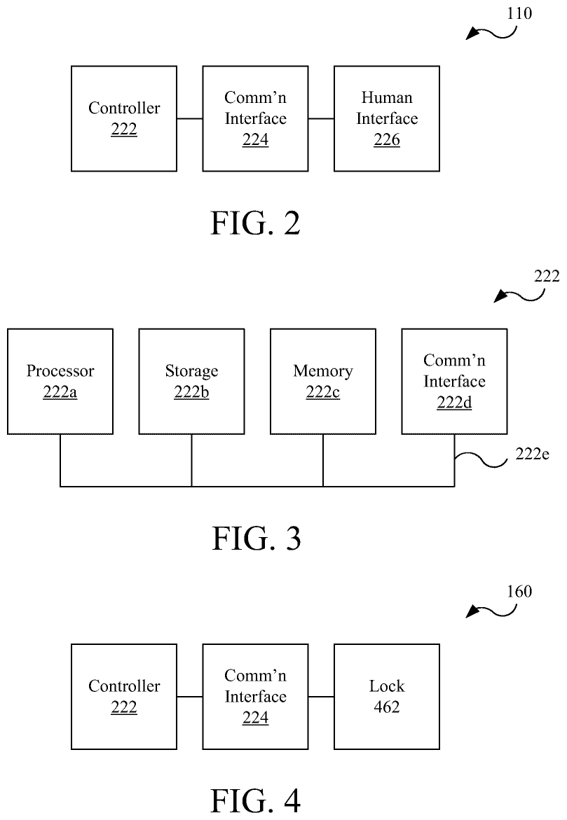

Referring to FIG. 2, the party computing systems 110 include one or more computing devices, each of which may generally include a controller 222, a communications interface 224, and a human interface 226. The controller 222 is configured to execute instructions to provide the functionality described herein and may have a hardware configuration as described below with respect to FIG. 3 or any other suitable configuration. The communications interface 224 is configured to be in communication with other aspects of the electronic access key system 100, directly or indirectly (e.g., via the network 102) to send and receive information therebetween, and includes any suitable hardware (e.g. modems, radios) that are configured to communicate via any suitable protocols. The human interface 226 is configured to provide outputs to and receive inputs from humans (e.g., the issuer 12, the recipient 14, or the presenter 15), for example, including audio-visual outputs (e.g., screens and/or speakers) and various inputs (e.g., keyboard, mouse or touch pad, touch screen, microphones, cameras). The recipient computing systems 140 and the presenter computing systems 150 are preferably configured as mobile devices that are portable to communicate directly with the access devices 160 associated with different ones of the physical spaces 16.

Referring to FIG. 3, the controller 222 generally includes a processor 222a, a storage 222b, a memory 222c, a communications interface 222d, and a bus 222e by which the other components of the controller 222 are in communication with each other. The processor 222a may be any suitable processing device, such as a central processing unit (CPU), configured execute the stored instructions. The storage 222b is a non-volatile, long-term storage device, such as a hard disc or solid state storage device capable of storing the instructions executed to be executed by the processor 222a (e.g., software programming) and other information and data. The storage 222b may be considered a non-transitory machine-or computer-readable medium. The memory 222c is a short term, volatile storage device, such as a random access memory (RAM) module. The communications interface 222d is configured to send signals from and receive signals to the controller 222 from other components of the devices or systems into which the controller 222 is incorporated.

Referring to FIG. 4, the access devices 160 are each configured to control access to the physical space 16 associated therewith. Each of the access devices 160 is associated with one of the issuers 12 and controlled thereby (e.g., via the issuer computing system 120) and includes, stored thereby, a public key 610c of the issuer 12. The access device 160 generally includes a controller 222 and a communications interface 224 (e.g., as described previously for the party devices) and a lock 462, directly or indirectly, operated by the controller 222. The lock 462 may be any type of electronically-operated lock physically associated with other hardware, such as a door, gate, elevator, or turnstile, that prevents access to the physical space 16 when locked and permits access to the physical space 16 when unlocked. For example, the lock 462 may include a bolt or pin that is retractable with via a solenoid or motor or include a magnetic to operably selectively release (i.e., lock and unlock) the lock 462. In one example, the controller 222 may directly control operation of the lock 462, for example, sending a signal (e.g., a voltage) directly to the lock 462 for operation thereof (e.g., to open or lock). In another example, the controller 222 may indirectly control operation of the lock 462, for example, by sending a signal containing information (e.g., a pass code) according to which another control system (e.g., computing device) then sends a signal (e.g., the voltage) directly to the lock for operation thereof.

Referring again to FIG. 1, the central computing system 182 includes one or more computing devices, centrally-located or distributed, that are individually and/or cooperatively configured to provide various of the functions as described here. Each of the computing devices of the central computing system 182 may, for example, be a cloud or server computing device that generally includes the controller 222 and the communications interface 224 similar to those described for the party computing system 110.

The blockchain computing system 184 is configured to store information in one or more blockchains and includes multiple computing devices (e.g., cloud or server computing devices) that operate as nodes that, by consensus, add, modify, and/or delete information from a distributed ledger that forms the blockchain. As discussed in further detail below, the blockchain computing system 184 is configured to store public digital identities 610′ of different parties and/or devices of the electronic access key system 100.

Referring to FIGS. 5-7, as referenced above, the electronic access key system 100 is configured to verify electronic access keys to provide recipients 14 access with the access device 160 to the physical space 16 by utilizing digital signatures and blockchain. As discussed in further detail below, the parties are each provided a cryptographic key pair that includes a private key and a public key. The digital signatures are generated using the private keys of the different parties and verified using public keys thereof. In issuing keys from the issuer 12 to the recipient 14, the user computing system 120 retrieves a public key of the recipient 14 from the blockchain and digitally signs the electronic access key with their private key. In granting a presenter 15 access to the space 16, the access device 160 verifies digital signatures of the issuer 12 and the presenter 15 with the public keys thereof in order to verify the electronic access key presented by the presenter 15 is untampered and issued by the issuer 12 and that the presenter 15 is the recipient 14 of the electronic access key. The access device 160 further verifies the validity of the access rights of the electronic access key presented thereto.

As used herein digitally signing generally refers to producing a digital signature with a signing algorithm from the private key of the party signing and a set of information. As also used herein, verifying a digital signature generally refers to verifying the authenticity of the set of information (e.g., its source and/or integrity) with a signature verifying algorithm from the public key of the signing party and the set of information. In one example, the signing algorithm may include hashing the set of information with a hashing algorithm (e.g., SHA256) and encrypting the hash with the private key, while the signature verifying algorithm may include decrypting the hash with the public key, re-hashing the set of information, and comparing the decrypted hash with the re-hash. If the hash and the re-hash match, both the source and the integrity of the set of information are verified as being authentic (i.e., the set of information being both from the signing party and unaltered). As understood in the art, the private key and the public key of a party form a cryptographic key pair. For example, the generating and verifying of digital signatures may be performed using JavaScript Object Notation Web Signature (“JWS”) methodology or any other suitable methodology.

Still referring to FIG. 5, as described in further detail below with respect to the method 800 and the submethods thereof, the electronic access key system 100 is configured for the issuer 12 to issue an electronic access key 720 to the recipient 14.

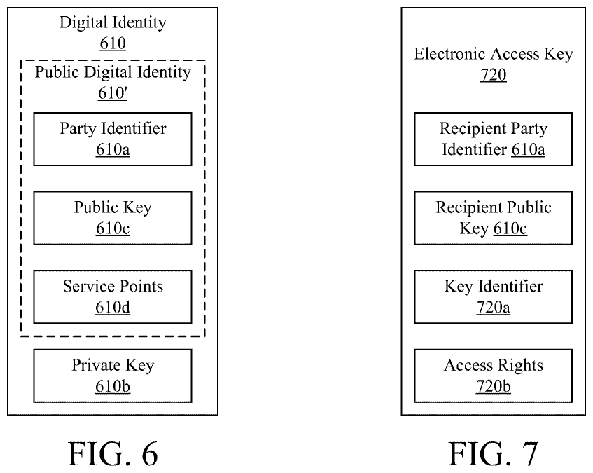

Referring also to FIG. 6, each party has a digital identity 610, which is a set of information associated with the party and includes a party identifier 610a, cryptographic key pair with a private key 610b and a public key 610c, and a service points 610d. The digital identity 610 is stored by the party computing system 110 (e.g., 120, 140, 150). The private key 610b is stored only by the party computing system 110, while the party identifier 610a, the public key 610c, and the service points 610d may be considered to form a public digital identity 610′ that is stored in a blockchain by the blockchain computer system 184 and is accessible by other parties. The service points 610d include information for sending messages or other information to the recipient 14 associated with the digital identifier 610a, such as to the recipient computing system 140 associated therewith. Furthermore, the public key 610c of the issuer 12 is stored by the access devices 160 associated with the issuer 12. The set of information forming the digital identity 610 may be stored in any suitable format (e.g., a text file, JavaScript Object Notation or “JSON”). Further aspects of the digital identity 610 are discussed in further detail below.

Referring to FIG. 7, an electronic access key 720 is a set of information that defines permissions for the recipient 14 to access a given space 16. The electronic access key 720 generally includes the party identifier 610a of the recipient 14 to which the electronic access key 720 is issued, the public key 610c of the recipient 14, an access key identifier 720a, and the access rights 720b. The public key 610c of the recipient 14 is obtained from blockchain by the issuer 12 (e.g., the issuer computing system 120 or system). The access key identifier 720a is an identifier (e.g., alphanumeric code) that is uniquely associated with the electronic access key 720 and no other electronic access keys 720. The access rights information includes information identifying one or more of the spaces 16 and the timeframe to which the recipient 14 is being permitted access to the one or more spaces 16. The set of information forming the electronic access key 720 may be in any suitable format (e.g., JSON). More generally, the electronic access key 720 may be considered an attestation. An attestation is a set of information provided by a party functioning as an issuer 12 to another party functioning as a recipient 14, which may be digitally signed by the issuer 12 to assure the integrity and source of the information. It should be noted that the role of a party (e.g., as the issuer 12 or the recipient 14) may change depending on who is issuing the attestation, as was described previously. For example, a hotel operator and a guest of the hotel may function, respectively, as the issuer 12 and the recipient 14 with respect to the electronic access key 720, but may instead function, respectively, as the recipient 14 and the issuer 12 with respect to attestations from the guest to the hotel operator (e.g., personal identification information or stay preferences).

During a setup operation of the access device 160, the access device 160 may be associated with the issuer 12 and one or more of the spaces 16. For example, during the setup operation, the public key 610c of the issuer 12 is provided to and stored by the access device 160. The public key 610c of the issuer 12 associated with the access device may be stored thereby at other such times, which are also prior to presentation by a presenter 15 to the access device 160 of the electronic access key 720 issued for that same access device 160 or the one or more spaces 16 associated with the access device 160. As such, the access device 160 may verify the digital signature of the issuer 12 in the electronic access key 720 without retrieving or accessing the public key 610c of the issuer 12 when the presenter 15 seeks access to the space 16.

When issuing the electronic access key 720, the issuer 12 digitally signs and sends the electronic access key 720 with the issuer computing system 120 to the recipient 14 and, in particular, to the recipient computing system 140 associated therewith. The electronic access key is digitally signed by the issuer 12, as described above, with the private key 610b of the issuer 12.

When seeking access to one of the spaces 16, the presenter 15 with the presenter computing system 150 presents (e.g., sends) the electronic access key 720 and digital signature of the issuer 12 to the access device 160, along with a digital signature of the presenter 15. For example, the presenter computing system 150 may digitally sign the electronic access key 720 or other set of information.

When presented with the electronic access key 720, the digital signature of the issuer 12, and the digital signature of the presenter 15, the access device 160 verifies whether the electronic access key 720 is untampered and was issued by the issuer 12, whether the presenter 15 is the recipient 14 of the electronic access key 720, and validity of the access rights 720b (e.g., that the electronic access key 720 is unrevoked and is valid for the space 16 associated with the access device 160 and the current time).

To verify both that the electronic access key 720 is untampered and that the electronic access key 720 was issued by the issuer 12 associated with the access device 160, the access device 160 verifies the digital signature of the electronic access key 720, as described above, using the public key 610c of the issuer 12 previously stored thereby (e.g., during the setup operation of the access device 160 described previously). If the digital signature is verified, the electronic access key 720 is verified to both have been issued by the issuer 12 associated with the access device 160 and untampered (e.g., not altered after issuance). If the digital signature of the electronic access key 720 is not verified, either the electronic access key 720 was not issued by the issuer 12, was altered (relative to issuance), or both, and the access device 160 denies the presenter 15 access to the space 16.

To verify that the presenter 15 is the recipient 14 of the electronic access key 720, the access device 160 verifies the digital signature of the presenter 15, as described above, using the public key 610c of the recipient 14, which was received in the electronic access key 720 presented by the presenter 15. If the digital signature is verified, the presenter 15 is verified to be the recipient 14 of the electronic access key 720. If the digital signature of the presenter 15 is not verified, the access device 160 denies the presenter 15 access to the space 16.

To verify the validity of the access rights of the electronic access key 720, the access device 160 determines whether the electronic access key 720 has been revoked and whether the access rights are valid for the space 16 associated with the access device 160 and the current time. To determine whether the electronic access key 720 has been revoked, the access device 160 compares the electronic access key identifier 720a to a list of revoked keys. The list of revoked keys is periodically updated and sent to the access device 160 (e.g., as any of the electronic access keys 720 is revoked), and then stored locally by the access device 160 prior to subsequent presentation of the electronic access key 720 thereto. It is noted that, because the access device 160 is able to verify the authenticity of the electronic access key 720 presented thereto (e.g., using the public key 610c of the issuer 12 stored thereon), the access device 160 does not itself need to store access rights associated with those persons seeking access. If the electronic key 720 has been revoked, is not valid for the space 16, or is not valid for the current time, the access device 160 denies the presenter 15 access to the space 16.

If all verifications pass (i.e., digital signature of the issuer 12 is verified to authenticate the source and unaltered state of the electronic access key 720, the digital signature of the presenter 15 to verify that the presenter 15 is the recipient of the electronic access key 720, and that the electronic access key 720 is not revoked and is valid for the space 16 and current time), the lock 462 is operated (e.g., by the controller 222 of the access device 160) to provide the presenter 15 access to the space 16 (e.g., opening the lock 462). As referenced above, if any of the verifications fail, the access device 160 operates the lock 462 to deny access to the recipient 14 (e.g., keeps the lock 462 locked).

It should be noted that the access device 160, in a preferred embodiment of the electronic access key system 100, is configured to perform the verifications itself without any real-time communication with any other devices other than the presenter computing system 150 (e.g., the central computing system 182, the blockchain computing system 184, or the issuer computing systems 120). Limiting both the communication and processing performed by the access device 160 in this manner may be especially advantageous in circumstances where access devices 160 do not have an ongoing power supply (e.g., are battery-operated) and/or where network communications may be limited. In this manner, verifications, including identity verification, may performed by different ones of the access devices 160 without communicating with the central computing system 182 or other central device and, therefore, may be considered to be a decentralized system and/or perform the verification in a decentralized manner.

Other embodiments are contemplated, however. In one embodiment, the access device 160 communicates with the blockchain computing system 184 to retrieve the public key 610c of the recipient 14 of the electronic access key 720 in order to verify that the presenter 15 is the recipient 14 of the electronic access key 720. In another embodiment, the access device 160 transmits the electronic access key 720 and the digital signatures of the issuer 12 and the presenter 15 received therewith to another computing system (e.g., an on premises computing device), which then obtains the public keys 610c of the recipient 14 and/or the issuer 12 of the electronic access key 720 from the blockchain computing system 184, verifies the digital signatures and the access rights as described above, and sends instructions to the access device 160 to operate the lock 462 to permit or deny access.

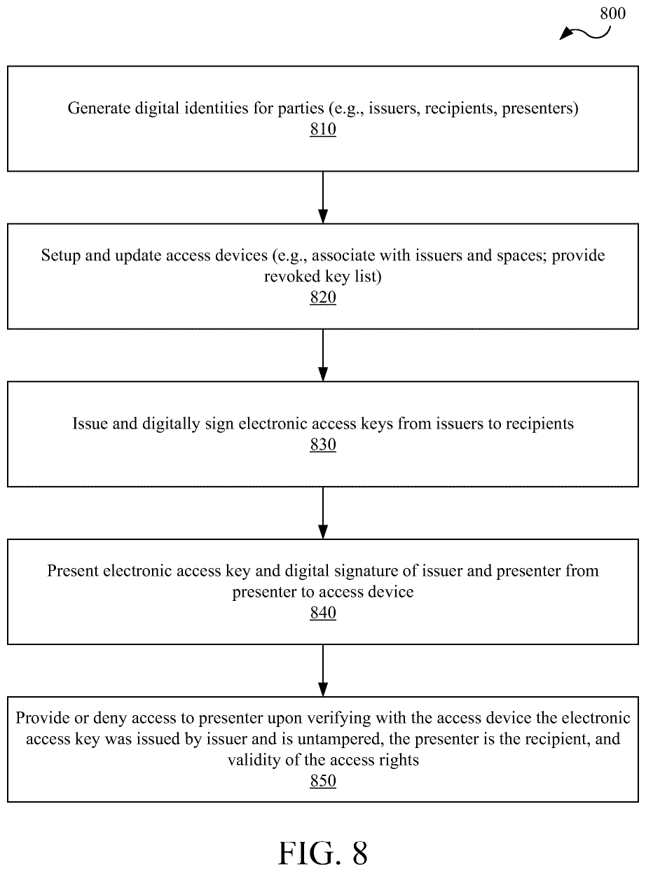

Referring to FIG. 8, the electronic access key system 100 and the various computing devices and systems thereof are configured (e.g., include software or written instructions) that perform the method 800 for providing users access to physical spaces with electronic access keys. The method 800 generally includes generating 810 digital identities for the parties, setting up and updating 820 the access devices 160 with the issuers 12, issuing 830 and digitally signing electronic access keys 720 to recipients 14, presenting 840 the electronic access key 720 and digital signatures of issuer 12 and the presenter 15 to the access device 160, and providing or denying access 850 to the physical spaces 16 upon verifying with the access device 160 the authenticity of the electronic access key 720, that the presenter 15 is the recipient, and the access rights 720b.

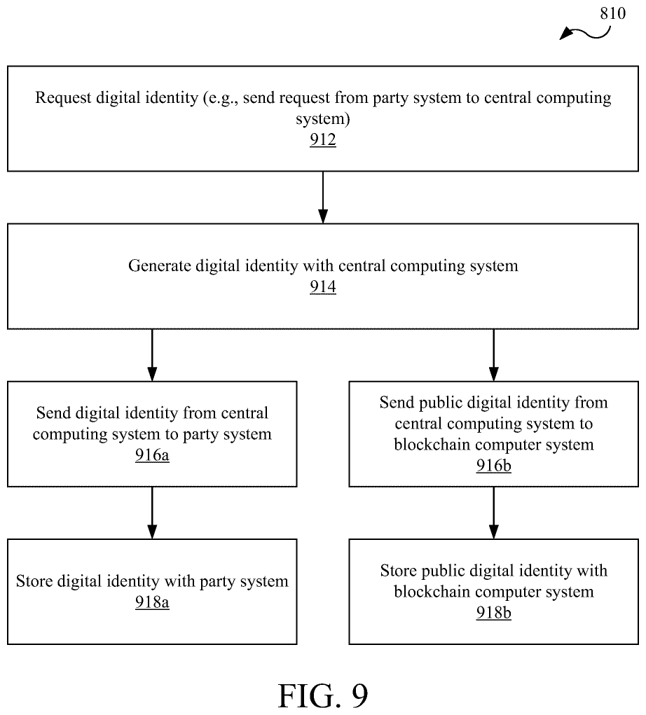

Referring again to FIGS. 5 and 6 and also FIG. 9, as referenced above, the digital identity 610 digital identities are created for the parties, which may be performed according to the method 810.

The digital identity 610 generally includes the party identifier 610a, the private key 610b, the public key 610c, and one or more service points 610d that are assigned to and/or otherwise associated with the party. The party identifier 610a is a unique user identifier assigned to the party, such as a numerical code (e.g., 16 digits). The private key 610b and the public key 610c form a key pair in which, as with digital signatures, the private key 610b is used for encryption (e.g., of a hash of a message) and the public key 610c is used for decryption. The private key 610b and the public key 610c may be generated according to any suitable cryptographic algorithm. The identifier 610a, the public key 610c, and the one or more service points 610d, but not the private key 610b, may be considered to cooperatively form a public digital identity 610′. The digital identity 610 is stored by the device of the respective party (e.g., 120, 140). The public digital identity 610′ is stored in a blockchain by the blockchain computing system 184.

A party may request generation of the digital identity 610 with the party computing system 110 associated therewith, which may be at their own initiative or upon invitation (e.g., originating from an issuer 12). In response to the request, the central computing system 182 generates and sends the digital identity 610 to the party computing system 110.

Referring to FIG. 9, the submethod 810 is described for generating and storing digital identities 610 and public digital identities 610′ for parties, which may include the issuers 12, the recipients 14, and the presenters 15, whether or not a recipient 14. The submethod 810 generally includes requesting 912, generating 914, sending 916, and storing 918 the digital identity 610.

The requesting 912 of the digital identity 610 is performed by the party computing system 110 associated with the party requesting the digital identity 610. For example, upon receiving an input from the party, the party computing system 110 sends a digital identity request to the central computing system 182. The digital identity request may include information about the requesting party, for example, service points 610d, which identify manners for communicating with the party and/or the party computing system 110, and/or personal identifying information (e.g., name, government identification number, date of birth). The personal identifying information may be used by the central computing system to verify the identity of the party (e.g., verifying with government databases), which may also provide an identity attestation (i.e., an attestation that the requesting party is the person or organization) that may be digitally signed by the identity verifying party (e.g., the government or another party).

The generating 914 of the digital identity 610 is performed by the central computing system 182 upon receiving the digital identity request from the party computing system 110. The generating 914 of the digital identity 610 generally includes generating the party identifier 610a to be unique from any other party identifiers 610a associated with other parties, and the key pair (i.e., the public and private keys 610b, 610c associated with each other) according to any suitable algorithms. The generating 914 of the digital identity 610 further includes generating or associating the service points 610d with the digital identity 610. The party identifier 610a, the private key 610b, the public key 610c, and the service points 610d form the set of information of the digital identity 610 and may be stored in any suitable file format (e.g., JSON, as referenced above).

The sending 916 of the digital identity 610 is performed by the central computing system 182. The sending 916 includes sending 916a the digital identity 610 to the party computing system 110 associated with the party for which the digital identity 610 was generated (e.g., according to the service points 610d of the digital identity 610 itself). The sending 916 also includes sending 916b the public digital identity 610′ to the blockchain computing system 184 for storage thereby.

The storing 918 includes storing 918a the digital identity 610 of the party, including the private key 610b, by the party device 910. The digital identity 610 may be stored in a secure manner, for example, being encrypted and requiring input of a credential of the party (e.g., facial recognition, fingerprint recognition, or passcode) to the party device 910 to access or otherwise use the digital identity 610.

The storing 918b also includes storing 918b the public digital identity 610′ of the party with the blockchain computing system 184 in one or more blockchains, as referenced above, by amending the blockchain consensus of the different nodes of the blockchain computing system 184 to amend the distributed ledger storing the digital identities 610 of different parties. The public digital identity 610 of the requesting party is publicly accessible in the blockchain (i.e., by others than the party with which the public digital identity 610′ is associated) to allow retrieval of the public key 610b associated therewith (e.g., when issuing electronic access keys 720).

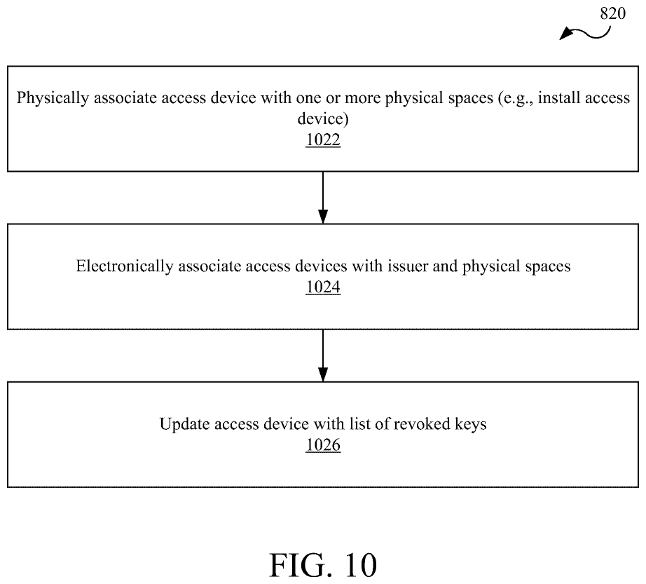

Referring to FIG. 10, as referenced above, the access devices 160 are set up and updated 820. The setting up and updating 820 generally includes physically associating 1022 the access device 160 with one or more physical spaces 16, electronically associating 1024 the access device with the issuer 12 and the one more physical spaces 16, and updating 1026 lists of revoked electronic access keys 720. The physically associating 1022 includes installing the access device 160 to the one or more physical spaces 16 (e.g., to a door that provides access to the physical space 16). The electronic associating 1024 includes storing, with the access device 160, the public key 610c of the issuer 12 and information identifying the physical spaces 16 physically associated with the access device 160. The updating 1026 includes generating and sending to the access device 160 and storing thereon listings up electronic access keys 720 that have been revoked. For example, the issuer 12 may revoke access rights to a particular physical space 16 from a recipient 14 in which case the recipient may still store and present the electronic access key 720 previously received but when presented to the access device 160 is identified as a revoked electronic access key 720. It should be noted that if access is revoked from one of multiple spaces, a new electronic access key 720 may be issued to the other physical spaces 16 to which the recipient 14 may still be granted access.

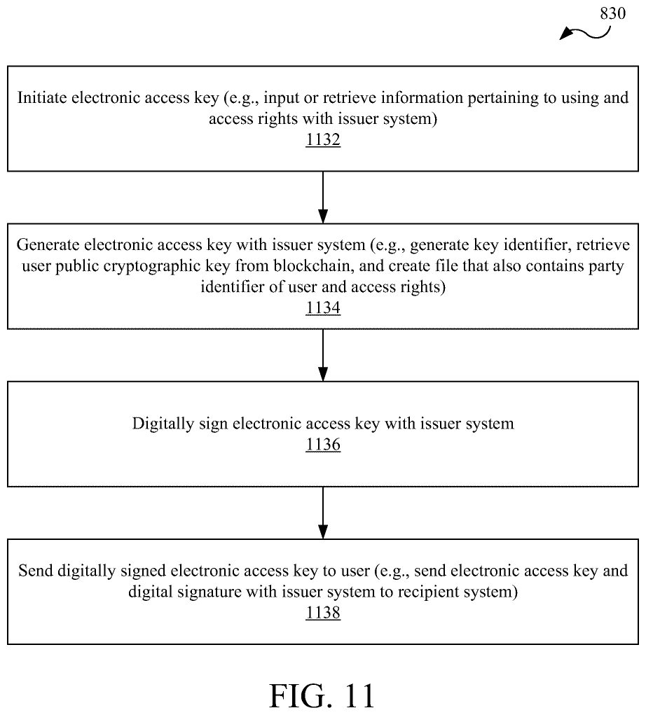

Referring again to FIGS. 5 and 7 and also FIG. 11, as referenced above, the electronic access keys 720 are issued by the issuer 12 with the issuer computing system 120, which may be performed according to the method 830.

As shown in FIG. 7, the electronic access key 720 is a set of information issued by the issuer 12 to the recipient 14 that authorizes the recipient 14 access to the physical space 16. As reference above, the electronic access key 720 generally includes the key identifier 720a, the access rights 720b, the party identifier 610a of the recipient 14 of the electronic access key 720, and the public key 610c of the recipient 14. The key identifier 720a is a unique user identifier (e.g., numeric or alphanumeric code) that is associated with the electronic access key 720 and no other electronic access keys 720. The access rights 720b include suitable information for identifying the permissions granted, which may generally include an identifier of the space 16 (e.g., an identifier of the space 16 itself of the access device 160 associated with the space 16) and a timeframe in which the recipient 14 is being authorized to access the space 16 (e.g., starting date and time).

The electronic access key 720 may be requested by the issuer 12 with the issuer computing system 120, for example, when processing hotel reservation information for the recipient 14. As part of the electronic access key request, the issuer 12 inputs suitable information for sending the electronic access key 720 to the recipient 14, which may include the service points 610d of the recipient 14, the party identifier 610a of the recipient 14 by which the service points 610d from the public digital identity 610′ stored in the blockchain, and/or other personal identifying information (e.g., name, contact information). In response to the request, the issuer computing system 120 generates, digitally signs, and sends the electronic access key 720 to the recipient computing system 140 of the recipient 14 with which the electronic access key 720 is associated, along with the digital signature.

Referring to FIG. 11, the submethod of issuing 830 a signed electronic access key 720 to the recipient 14, generally includes initiating 1132, generating 1134, signing 1136, and sending 1138 the electronic access key 720.

The initiating 1132 of the electronic access key 720 is performed, for example, by the issuer 12 with the issuer computing system 120, which includes inputting information pertaining the recipient 14 and the access rights 720b. The information pertaining to the recipient 14 is suitable to ensure the electronic access key 720 is sent to the recipient 14 and may include, for example, the party identifier 610a, the service points 610d, and/or personal identifying information of the presenter 15 (e.g., name, date of birth, contact information). As referenced above, the access rights 720b include the identifier of the space 16 and the timeframe in which the recipient 14 is authorized to access the space 16.

The generating 1134 of the electronic access key 720 is performed by the issuer computing system 120, which obtains the public key 610c from the public digital identity 610′ stored in the blockchain (e.g., requests and receives the public key 610c for the party identifier 610a from the blockchain computing system 184) and generates the key identifier 720a. The issuer computing system 120 then stores the set of information of the electronic access key 720 into a suitable file format (e.g., JSON, as referenced above), including the party identifier 610a of the recipient 14, the public key 610c of the recipient 14, the key identifier 720a and the access rights 720b.

The signing 1136 of the electronic access key 720 is performed by the issuer computing system 120, as described above, by generating a digital signature using a signing algorithm from the electronic access key 720 and the private key 610b of the issuer 12.

The sending 1138 of the electronic access key 720, includes sending the electronic access key 720 and the digital signature with the issuer computing system 120 to the recipient computing system 140. The combination of the electronic access key 720 and the digital signature by the issuer 12 may be referred to as a digitally signed access key.

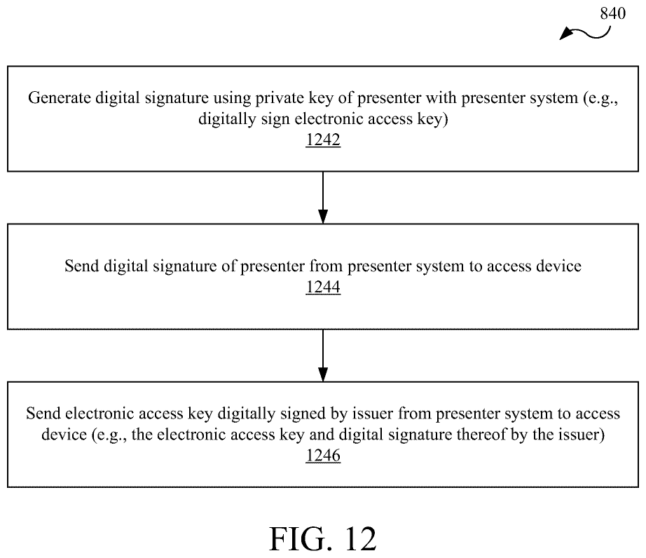

Referring to again to FIG. 5 and also FIG. 12, when the recipient 14 seeks access to the physical space 16, the recipient computing system 140 presents the digitally signed electronic access key 720 (e.g. the electronic access key 720 and the digital signature of the issuer 12) and a digital signature of the presenter 15 to the access device 160 associated with the physical space 16. The presenter computing system 150 sends the digitally sends the electronic access key 720, the digital signature thereof of the issuer 12, and the digital signature of the presenter 15 to the access device 160 via any suitable wireless communications protocol (e.g., Bluetooth, Wi-Fi, near-field communication (NFC)). The digitally signed key is as described previously (i.e., including the electronic access key 720 and the digital signature thereof). The digital signature of the presenter 15 may be made in relation, for example, to the electronic access key 720 or other information.

Referring to FIG. 12, the submethod of presenting 840 a signed electronic access key 720 generally includes generating 1242 a digital signature of the presenter 15 with the presenter computing system 150, sending 1244 the signature of the presenter 15, and sending 1246 the electronic access key 720 and the digital signature thereof by the issuer 12.

The generating 1242 of the digital signature of the presenter 15 is performed by the presenter computing system 150 with the private key 610b of the presenter 15 and may be performed, as described above, with respect to the electronic access key 720 or other information.

The sending 1244 digital signature of the presenter 15 and the sending 1246 of the electronic access key 720 and the digital signature thereof by the issuer 12 is performed with the presenter computing system 150 using any suitable wireless communication protocol (e.g., via Bluetooth, Wi-Fi, NFC, or other suitable communications protocol) when the presenter 15 seeks access to the space 16 and, thereby, is in relatively close proximity to the access device 160 (e.g., can place the presenter computing system 150 within a few inches of the access device 160).

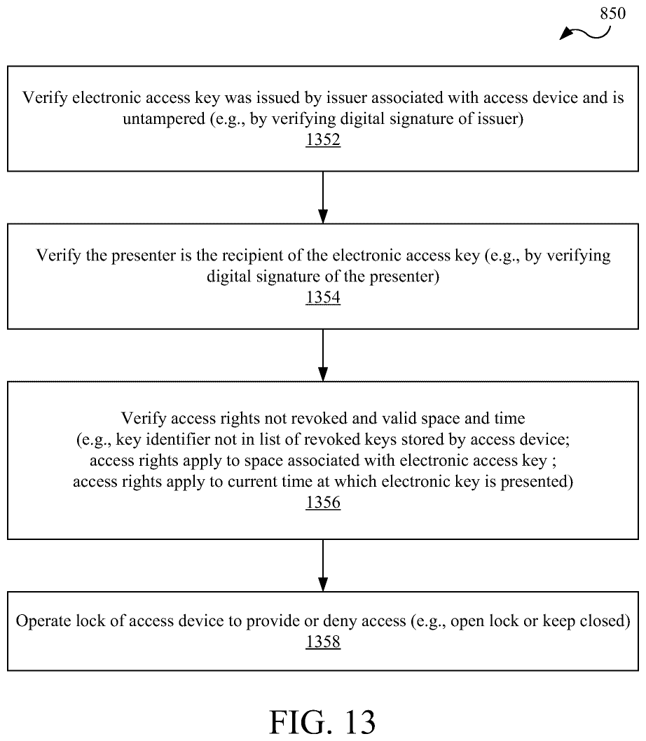

Referring again to FIG. 5 and also to FIG. 13, when the access device 160 receives the digitally signed electronic access key 720 (e.g., the electronic access key 720 and the digital signature thereof by the issuer 12) and the digital signature of the presenter 15, the access device 160 verifies the digital signature of the issuer 12 to verify that the electronic access key 720 is untampered and issued by the issuer 12, verifies the digital signature of the recipient 14 to verify that the presenter 15 is the recipient 14 of the electronic access key 720, and verifies the validity of the access rights 720b. The public key 610c of the issuer 12, which was previously stored by the access device 160, is used to verify that the digital signature of the issuer 12. The public key 610c of the recipient 14, which was received in the electronic access key 720, is used to verify the digital signature of the presenter 15.

Referring to FIG. 13, the method of providing or denying 850 access to the presenter 15 is performed by the access device 160 and generally includes verifying 1352 that the electronic access key 720 is not tampered and cryptographically signed electronic access key 720, verifying 1354 that the presenter 15 is the recipient 14, verifying 1356 that the access rights are valid, and operating 1358 the lock 462 to provide or deny access to the recipient 14 according to the verifying 1352, 1354, 1356. While the steps of verifying 1352, 1354, 1356 and the substeps thereof are depicted as occurring in order, it should be understood that they may be performed in any suitable sequence (e.g., in different orders and/or in parallel).

The verifying 1352 that the electronic access key 720 was issued by the issuer 12 and is untampered is performed by verifying the digital signature by the issuer 12 thereof with the access device 160, as described above, using the public key 610c of the issuer stored on the access device 160. Alternatively, the verifying 1352 may be described as verifying the digital signature by the issuer 12 of the electronic access key 720, which is again performed using the public key 610c of the issuer previously stored on the access device 160.

The verifying 1354 that the presenter 15 is the recipient 14 generally includes verifying the digital signature of the presenter 15, which is performed by the access device 160, as described above, using the public key 610c of the recipient 14 received as part of the electronic access key 720. Alternatively, the verifying 1354 may be described as verifying the digital signature by the presenter 15.

The verifying 1356 of the validity of the access rights 720b of the electronic access key 720 includes verifying that the electronic access key 720 has not been revoked, the access rights apply to the space 16 associated with the access device 160, and the access rights are valid for the current time. In verifying that the electronic access key 720 has not been revoked, the access device 160 compares the key identifier 720a to key identifiers in a revocation list stored by the access device 160 and received from the issuer computing system 120. In verifying that the access rights 720b are associated with the space 16, the space 16 identified in the access rights 720b is compared to the identified space stored by the access device 160 (e.g., comparing identifiers of the space 16 in the electronic access key 720 and the access device 160).

The operating 1358 of the lock 462 to permit or deny access includes opening the lock if the presenter 15 is verified to be the recipient 14 of the electronic access key 720 being presented, the non-tampering and source of the electronic access key 720, and the access rights 720b are all verified. If any are not verified, the lock 462 is operated (e.g., kept locked) to prevent the presenter 15 access to the space 16.

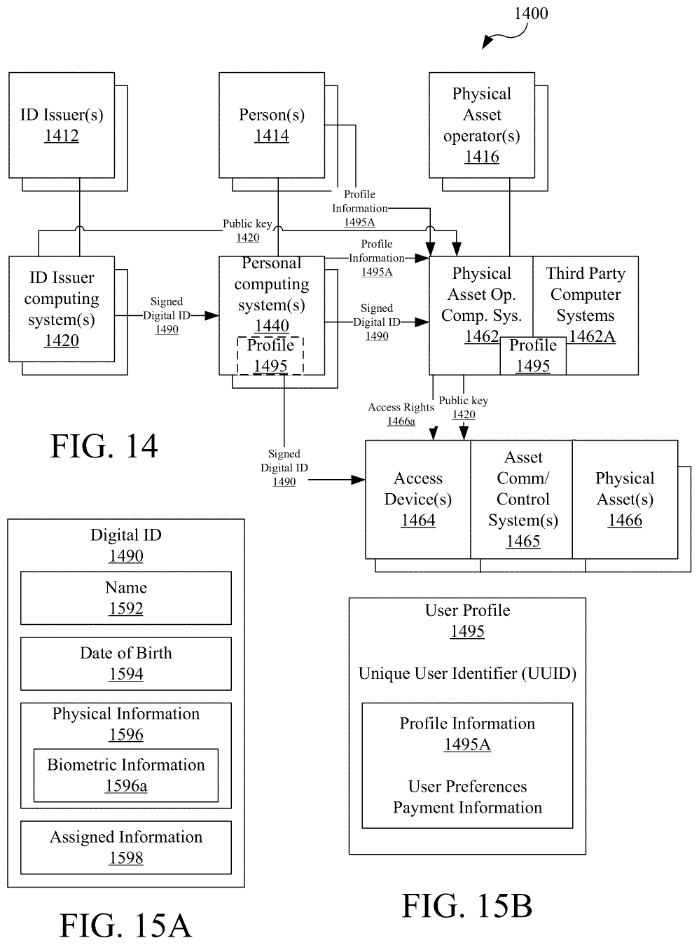

Referring to FIG. 14, an electronic access key system 1400 is configured to utilize digital identifications 1490 (e.g., digital or mobile driver's license), which may be referred to as a digital IDs 1490. The digital IDs 1490 are issued by ID issuers 1412 via ID issuer computing systems 1420 to individual persons 1414. The digital IDs 1490 are received by the persons 1414 via personal computing systems 1440 associated therewith. Each of the persons 1414 may present their digital ID 1490 via their personal computing systems 1440 to physical asset operators 1416 via physical asset operator computing systems 1462 and access devices 1464 operated by the physical asset operator 1416 and associated with the physical assets 1466 thereof.

Furthermore, each person 1414 may have a profile 1495 that includes profile information 1495A pertaining to the person 1414, such as user preferences pertaining to different physical assets 1466. The profile 1495 may be stored by the personal computing system 1440 and presented thereby in conjunction with the digital ID 1490, for example, with the person 1414 providing consent for the profile 1495 to be used by the physical asset operator 1416. Instead or additionally, the profile 1495 may be generated and/or stored by the operator computing systems 1462, for example, with the person 1414 providing consent and the profile information 1495A via their personal computing system 1440 and/or direct input to the physical asset operator computing system 1462. The operator computing system 1462 may include a third party computer system 1462A, which may be considered part of the operator computing system 1462, which may interface with the operator computing system 1462 (e.g., to store and/or retrieve information, such as the profile 1495) but which is operated and/or owned by an entity separate from the physical asset operator 1416 (e.g., by a vendor thereto). In such case, the third party computer system 1462A may also interface with other physical asset operator computing systems 1462 of different physical asset operators 1416 and store a single profile 1495 for a given person 1414. As indicated, the profile 1495 may include user preference information, which may pertain to the physical asset 1466 operated by the physical asset operator 1416, which may relate to payment information of the person 1414 (e.g., credit card information to which charges may be made for the physical asset 1466, such as tokenized payment information associated with the credit card), the selection of the physical asset (e.g., preferences for floor, direction, particular room, accommodations of a hotel room, or type of a rental car) for which access rights 1466a are granted to the person 1414, controllable parameters of the physical asset for the person 1414 (e.g., preferences for temperature, lighting, shades), and/or other provisions associated with the physical asset 1464 (e.g., types of food, food allergies, detergent allergies, among others).

The physical asset operators 1416 provide access rights 1466a to the physical assets 1466 to each of the persons 1414 by first verifying the digital ID and then by, for example, associating a unique user identifier (e.g., “UUID”) of the person 1414 with the physical asset 1466 for a given time period during which access is to be granted. The unique user identifier of the person may be contained in the digital ID 1490 or be derived from information contained in the digital ID. More particularly, the operator computing system 1462 generates the access rights 1466a, which are transferred to the access devices 1464 associated with the physical asset 1466 for which the access rights 1466a are granted to the person.

The physical asset owner computing system 1462 may be further configured to select a physical asset 1466, issue the access rights 1466a, and/or configure the physical asset 1466 according to the user profile 1495. The user profile 1495 is, for example upon consent of the person 1414, generated and stored with the profile information 1495A in association with the unique user identifier (UUID). For example, the physical asset computing system 1462 may select the physical asset 1466 according to the user profile 1495 (e.g., a particular hotel room and/or rental car with certain characteristics that match user preferences in the user profile 1495), which may be considered part of issuing the access rights 1466a. The physical asset computing system 1462 may also configure and issue the access rights 1466a according to the user profile 1495, for example, a check out time that is determined according to a user preference (e.g., for late check out). The physical asset computing system 1462 may also configure the physical asset 1466 according to the user profile 1495, for example, by sending instructions to an asset communication and/or control system 1465 associated with the physical asset 1466, such as a control system for controlling parameters of the physical asset 1466 (e.g., a thermostat, lighting, or shade controls) and/or a communication system according to which physical provisions may be communicated and subsequently provided (e.g., communicating to staff food preferences, allergies). Still further, the physical asset computing system 1462 may conduct or initiate financial transactions according to the user profile 1495 (e.g., charging or otherwise securing funds from the payment method stored in the user profile 1495 and/or indicating that a payment method is required). In these manners, the person 1414 may present their digital ID 1490 to the physical asset operator computing system 1462, which reduces friction in obtaining access rights to a physical asset 1466 desirable thereto.

The access rights 1466a may be issues to the user as an access credential (e.g., the electronic key 720), which is stored by the personal computing device 1440 and presented to the access device 1464 to pre provided access thereto in the manners described previously (e.g., upon validating the identity of the user and the validity of the access credential, for example, using public keys of the user and the public key of the asset operator, as described previously). In this manner, the access rights 1466a may also be considered access credentials.

The access device 1464 then provides access to the person 1414 by first verifying the digital ID 1490 presented thereto, via personal computing device 1440, and then permitting access the physical asset 1466 if access rights 1466a are determined to be valid for the person 1414 for the physical asset 1466 at the time presented. The access device 1464 may, for example, be an electronic door lock (e.g., having a bolt, magnet, or other mechanical device that restricts access to the physical asset 1496 and is actuated to permit access), such as smart door lock for a building door or a car door lock. The physical asset 1496 may, for example, be a hotel room, office, rental car, or other physical asset for which access is controlled. The ID issuers 1412, individual persons 1414, and the physical asset operators 1416 are different persons or entities, which are generally unaffiliated with each other (e.g., one does not have control or authority over the other).

Referring to FIG. 15A, a digital ID 1490 is a digital representation of common information that might otherwise be provided on a physical ID and may include further information particular to the digital ID 1490. For example, the digital ID 1490 may include name information 1592 (e.g., given name, middle name, and given name (e.g., last name or surname)), birthdate 1594, physical characteristics 1596 (e.g., height, eye color, gender, and biometric information 1596a), and assigned information (e.g., driver's license or ID number). The biometric information 1596a may, for example, include biometric identifying information that includes physical characteristics that uniquely identify the person from other persons (e.g., facial information, fingerprint information, and/or eye information).

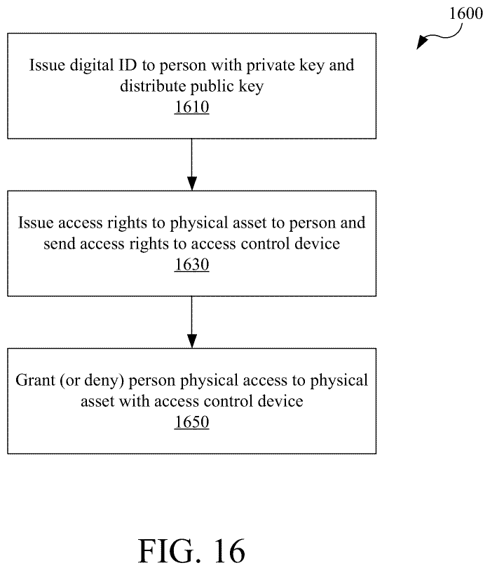

Referring to FIG. 16, the electronic access key system 1400 and the various computer devices and systems thereof are configured to implement methods whereby the person 1414 is issued their digital ID 1490, is issued the access rights 1466a to a physical asset 1466, and is then granted access to the physical asset 1466. The method 1600 generally includes issuing a digital ID to a person with a private key and distributing a public key 1610, issuing access rights to a person and sending the access rights to an access control device 1630, and granting or denying a person access to the physical asset with the access control device 1650.

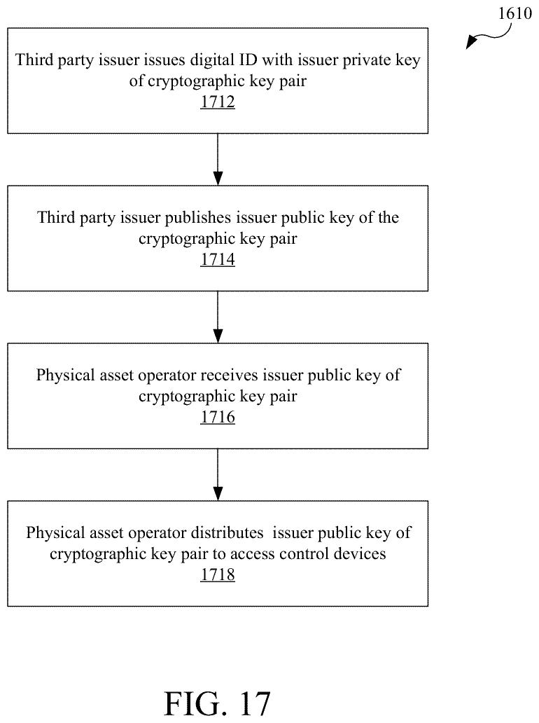

Referring to FIG. 17, the issuing of the digital ID and the distributing of the public key 1610 generally includes issuing 1712 the digital ID, publishing 1714 the public key, receiving 1716 the public key, and sending 1718 the public key.

The issuing 1712 of the digital ID is performed with a computing system of the ID issuer (e.g., the ID issuer computing system 1420). The digital ID may be the digital ID 1490, as described previously. The issuing 1712 of the digital ID includes generating and signing a digital file with the private key of the issuer, as described previously (e.g., hashing and encrypting the digital file with the private key of a cryptographic key pair of the issuer, the result of which forms the digital signature). The digital ID may be hashed and/or encrypted in a manner that allows for selective disclosure of information contained in the digital ID. The digital file may contain the information of the digital ID (e.g., the name information 1592, the birth date 1594, the physical characteristics including any biometric information 1596a, and/or the assigned information 1598). The signed digital ID (i.e., the digital file with the digital signature) is then sent from the computing system of the ID issuer to a computing system of the person for which the digital ID is issued (e.g., the personal computing system 1440). The signed digital ID is stored by the computing system of the person, for example, using an application specific to storing, accessing, and sending digital IDs issued by the issuer thereof or another application configured to store the digital ID.

The publishing 1714 of the public key is performed by the computing system of the ID issuer, which may be a different computing device or set of devices than that which issued the digital ID. The publishing 1714 of the public key may include sending the public key or making available (e.g., for download) the public key to the physical asset operator directly or indirectly (e.g., through an intermediary, such as an aggregator of public keys for digital IDs). The public key, as referenced above, is part of a cryptographic key pair that includes the private key used in the issuing 1712 and, specifically, the signing of the digital ID by the ID issuer.

The receiving 1716 of the public key is performed by a computing system of the physical asset operators, such as the physical asset operators computing system 1462, and may be further performed by the access devices 1464 of the physical asset operators, for example, by downloading or otherwise accessing or retrieving the public key from the computing system of the ID issuer or a third party.

The sending 1718 of the public key is performed by the computing system of the physical asset operators and includes sending the public key to the access control devices (e.g., the access control devices 1464 associated therewith), unless the access control devices receive the public key directly from the computing system of the ID issuer or third party.

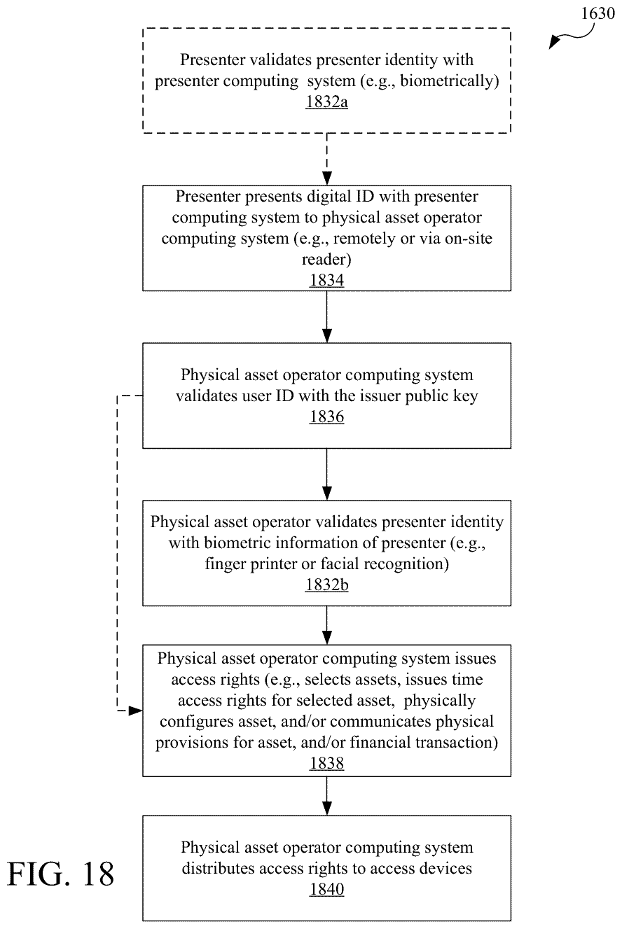

Referring to FIG. 18, the issuing of access rights to a person and sending the access rights to access control device 1630 is performed by a computing system of the physical asset operator, such as the physical asset operator computing system 1462 of the physical asset 1416, in conjunction with a computing system of the person, such as the personal computing system 1442 of the individual person 1414. The issuing and sending of the access rights generally includes validating 1832a or 1832b the identity of the person presenting the digital ID, presenting 1834 the digital ID, validating 1836 the digital ID, issuing 1838 the access rights, and distributing 1840 the access rights to access devices.

The validating 1832a, 1832b the identity of the person is performed by either a personal computing system of the person to present the digital ID (e.g., the personal computing system 1842 of the person 1814) before the presenting 1834 of the digital ID (represented by 1832a), or is performed by the computing system of the physical asset operator (e.g., the computing system 1862 of the physical asset operator 1816) in conjunction with a peripheral device after the presenting 1834 of the digital ID (represented by 1832b). More particularly, the identity of the person is validated using biometric data, for example, in one of known or future manners using a biometric security protocol of the computing system of an operating system of the computing system of the person or of an application for storing the digital ID (i.e., validating 1832a), or is validated using software of the computing system of the physical asset operator (i.e., validating 1832b). For example, the biometric security protocol may include receiving biometric information of the user (e.g., fingerprint, facial features, and/or eye features) with suitable hardware of the computing system of the person or the physical asset operator (e.g., fingerprint scanner, cameras, LIDAR) and comparing the received biometric information to that stored for the person associated with the personal computing device and/or the digital ID (e.g., biometric information 1596a).

The presenting 1834 of the digital ID is performed with the computing device of the presenter (e.g., the computing system 1842 of the person 1814) in conjunction with the computing system of the physical asset operator (e.g., the computing system 1862 of the physical asset operator 1816). The presenting 1834 may be performed directly (e.g., wireless transfer between the computing systems) or remotely (e.g., via an intermediate network). The presenting 1834 of the digital ID includes sending the signed digital ID (e.g., the file of the digital ID and the digital signature).

The validating 1836 of the digital ID is performed with the computing system of the physical asset operator (e.g., the computing system 1462 of the physical asset operator 1416) in the manner described previously. More particularly, the public key is retrieved and used to validate the digital ID (e.g., decrypt the digital signature with the public key, re-hash the digital ID, and compare decrypted hash with the re-hash).

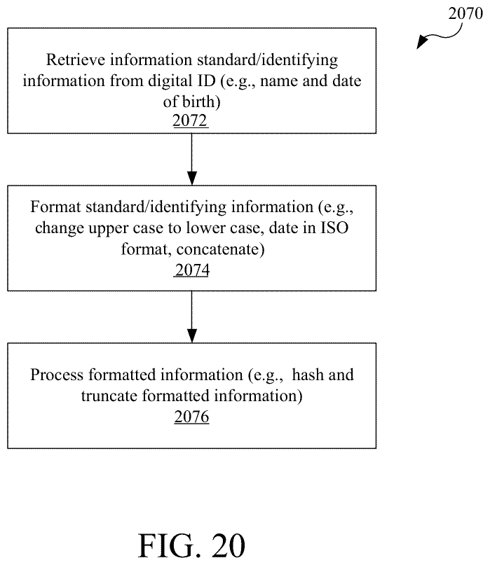

The issuing 1838 of the access rights is performed with the computing system of the physical asset operator (e.g., the computing system 1462 of the physical asset operator 1416). More particularly, the computing system associates one or more physical assets and/or access devices associated with the physical assets (e.g., the physical asset 1466 with the access device 1464 of the physical asset operator 1416) with the person (e.g., the unique user identifier thereof) for a given timeframe. The access rights may, for example, include an identifier of the physical asset, a start time and/or date, an end time and/or date, and the unique user identifier of the person to whom the access rights are issued. The unique user identifier of the person may, for example, include the assigned information assigned by the ID issuer 1412 to the person 1414 (e.g., the assigned information 1598, such as a driver's license number) or may be derived from other information of the person contained in the digital ID (e.g., name 1592 and date of birth 1594), as discussed in further detail below with respect to FIG. 20.

As further referenced above, the issuing 1838 of the access rights may performed according to the user profile 1495 shown in FIG. 15B. The issuing 1838 of the access rights may be considered to include selecting a physical asset, determining and issuing access rights to that physical asset, physically configure that physical access, and/or physically provisioning that physical asset. In one example, the user profile 1495 is sent to the computing system 1462 of the physical asset in conjunction with the presenting 1834 of the digital ID. Alternatively, the user profile 1495, upon the validating 1836 of the digital ID, is stored by and retrieved from the computing system of the physical asset operator. For example, the computing system of the physical asset operator retrieves the user profile 1495 according to the unique user identifier, which is part of the digital ID 1490 or is derived therefrom. The access rights are then issued according to the information 1495A of the user profile 1495, for example, according to preferences of the person 1414. The issuing 1838 may include selecting the physical asset (e.g., the physical set 1466, such as a hotel room or rental car according to user preferences therefore as contained in the user profile (as described previously). The issuing 1838 includes issuing access rights to the physical asset as requested by the user (e.g., selected location and days) and may further include determining the access rights according to the user preferences that may extend across different usages of the physical asset or similar physical assets (e.g., late checkouts). The issuing 1838 may further include physically configuring the physical asset according to the user profile, for example, by sending control signals to a physical control system (e.g., the asset control system 1465 for temperature, lighting, shades of the physical asset). The issuing 1838 may still further include communicating physical provisions, for example, by sending control signals to a physical asset communication system (e.g., the asset communication system 1465, which may communicate user preferences to staff that physical provision the physical asset). The issuing 1838 of the access rights may further initiate a financial transaction, for example, by charging the payment information before (e.g., as a gating function) completing the issuance of the access rights.

The distributing 1840 of the access rights is performed with the computing system of the physical asset operator by sending the access rights to the access devices, for example, via an intermediate network.

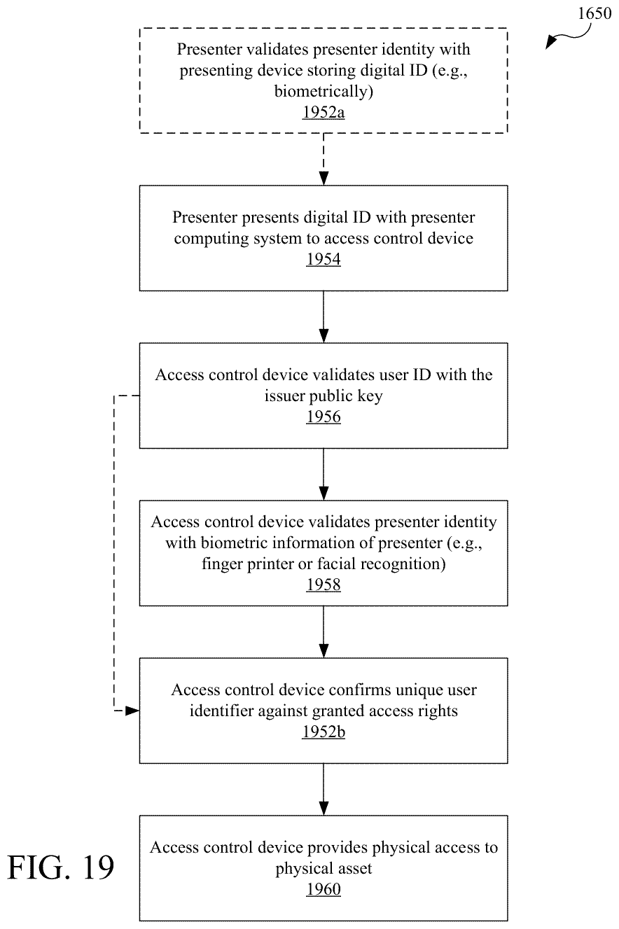

Referring to FIG. 19, granting or denying a person access to the physical asset with the access control device 1650 is performed by the access device associated with the physical asset of the physical asset operator (e.g., the access device 1464 associated with the physical asset 1466) in conjunction with the computing system of the person, such as the personal computing system 1442 of the individual person 1414. The granting or denying access 1650 generally includes validating 1952a or 1952b the identity of the person presenting the digital ID, presenting 1954 the digital ID, validating 1956 the digital ID, confirming 1958 the access rights for the presenter, and providing physical access 1960 to the physical asset.

The validating 1952a or 1952, the presenting 1954, and the validating 1956 are performed in the manners described with respect to the issuing and sending of the access rights, albeit using the access devices (e.g., the access device 1464) in conjunction with the personal computing device (e.g., the personal computing device 1444) instead of the physical asset operator computing system in conjunction with the personal computing device. It should be noted, however, that various functions may be performed by the access device in conjunction with the computing system of the physical asset operator, for example, with the access device 1464 sending biometric information received thereby to the computing system 1462 for validation (i.e., for comparison of the biometric information) and/or sending the digital ID to the computing system 1462 for validation (i.e., verifying the digital signature with the public key).

The confirming 1958 of the access rights is performed by the access device (e.g., the access device 1464 corresponding to the physical asset 1466), for example, by searching access rights stored thereby for the unique user identifier of the presenter and the corresponding time window during which the presenter may be permitted access to the physical asset. As referenced above, the unique user identifier may be the assigned information 1598, which may be referred to directly when confirming 1958 the access rights, or which may be derived from the other information (e.g., name 1592 and the date of birth). In the case of the unique user identifier being derived from the digital ID, the access device may directly or indirectly (via by way of another computing system or device in communication therewith) derive the unique user identifier.

The providing 1960 of the physical access to the physical asset is performed by the access device 1464. If the access rights are confirmed (i.e., the presenter has been assigned access rights for the time during which the digital ID is presented to the access device), the access device permits the presenter to physically access the physical asset (e.g., operates the locking mechanism thereof to unlock a door to the physical asset). If the access rights are not confirmed (i.e., no access rights were granted or stored for the presenter during which the digital ID is presented to the access device), the access device denies the presenter physical access to the physical asset (e.g., maintains the locking state of the locking mechanism).

Referring to FIG. 20, and as referenced above, the access rights are associated with unique user identifier when issued to the individual and are later confirmed using that same unique user identifier. The unique user identifier may be derived from information from the digital ID, which may be done in a standard format that uses common information from different formats of digital IDs (e.g., issued by different ID issuers), thus allowing the system 1400 to be usable with different formats of digital IDs. The unique user identifier may, for example, be derived from an algorithm executed when both issuing the access rights (i.e., by the computing system of the physical asset operator) and when verifying the access rights (i.e., by the access device of the physical asset operator). Generation and subsequent usage of the unique user identifier may be used in other contexts besides in association with access rights, for example, when storing data in an anonymized manner that is retrievable by use of the digital ID. In such instances, a system may be other than an electronic key access system 1400 and the party generating and using the unique digital identifier may have another function than operating a physical asset.

For example, a method of deriving a unique user identifier 2070 may be performed. The method 2070 generally includes retrieving 2072 standard information form the digital IDs, formatting 2074 the standard information, and computing 2076 the unique user identifier from the formatted information.

The retrieving 2072 of the standard information, includes obtaining from the digital ID of the person what is generally standard information across different formats of digital IDs and sufficient for differentiating one person from another. The standard information may, for example, include the name 1592 of the person (e.g., given name, middle name, and surname or family name) and the date of birth 1594 of the person.

The formatting 2074 of the standard information includes processing each piece of information into a common format and then combining the standard information. The person's name is converted to a standard name format. In one example, the name 1592 of the person may be formatted by converting the person's full legal name (i.e., given name, middle name, and surname or family name) into lower case, which may further include removing diacritics, accents, and/or other special characters. For example, the name “José Michael Doe” may be converted to “jose michael doe” by changing upper case letters to lower case and removing the acute accent from the letter “é.” The person's date of birth is converted to a standard date format, such as ISO 8601 format. For example, the date “January 1, 1995,” may be converted to “1995-01-01.” The formatting 2074 further includes combining any of the converted information, for example, by using a concatenate function for the converted information with or without a delimiter (e.g., “|”). For example, “José Michael Doe” having a date of birth of “January 1, 1995” may be combined as “jose michael doe|1995-01-01.”

The processing 2076 of the combined information may be used to anonymize or otherwise remove personal identifying information. For example, the combined information may be processed using a hash function, the result of which may or may not be further truncated (e.g., to a shortened number of characters). Hashing may, for example, be performed using HMAC-SHA256 with a secret key (e.g., known only to the physical asset operator). The resultant hashed character string may be truncated (e.g., to 128 bits). The resultant hashed and/or truncated character string need not be decrypted and beneficially is not decrypted, so as to prevent reconstructing personal information therefrom. As noted above, the method of deriving the unique user identifier 2070 may be performed both when issuing access rights for the person and when granting physical access rights to the person.

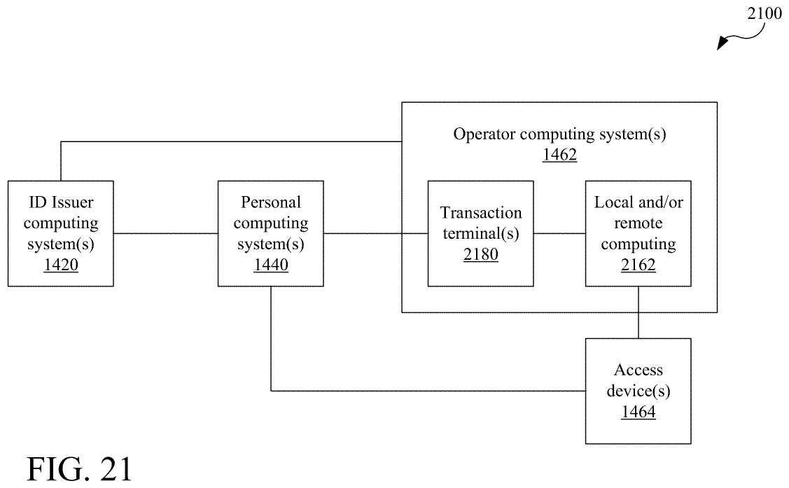

Referring to FIGS. 21-26, systems, methods, and devices are provided that implement and refine the electronic access key systems 100, 1400 and aspects thereof. A system 2100 is configured as described previously for the electronic key system 1400 and includes an ID issuer computing systems 1420, personal computing systems 1440, the asset operator computer system 1462, and the access devices 1464.

Each of the ID issuer computing system 1420 is associated with one of multiple ID issuers 1412 (e.g., governmental authorities) and generates, signs, and issues digital IDs 1490 to persons 1414 as described previously. Each of the ID issuer computing systems 1420 may be configured and operate as described previously (e.g., performing various aspects of the methods 1600, 1610). Generally speaking, each of the ID issuer computing systems 1420 is a computing system that may be configured as described for the computing systems 110 (e.g., including one or more of the computing systems 110, such as personal computers or servers, in communication with each other and other party computing systems 110).

Each of the personal computing systems 1440 is associated with one of multiple persons 1414 whom may also be referred to as users. Each of the personal computing systems 1440 is generally configured, as described previously, to store and present various information (e.g., the digital IDs 1490, payment information, access rights 1466a and/or electronic keys 720), as well as validate the identity of the person presenting the digital ID 1490 and other information. Generally speaking, each of the personal computing systems 1440 is configured as described for the computing systems 110 and, preferably, is configured as a portable or mobile computing device (e.g., a mobile device or smartphone). The access rights 1466a, the electronic keys 720, and/or the term “access credential” may be used interchangeably. It should be noted that the access rights 1466a, the electronic keys 720, and/or access credentials may be formatted and/or provided to the user in various different manners but preferably as an electronic key that is digitally signed by the asset operator.

Each of the asset operator computing systems 1462 is associated with one of multiple asset operators 1416. Each of the asset operator computing systems 1462 is generally configured, as described previously, receive and validate digital ID 1490, issue access rights 1466a and/or electronic keys 720, and, as described in further detail below, perform additional functions and transactions with the personal computing systems 1440 of the multiple persons 1414. Each of the asset operator computing systems 2100 includes one or more local and/or remote operator computing devices or systems 2162, which may be configured as one described for one of the computing systems 110 described previously (e.g., a personal computer and/or server), and includes or is in communication with one or more transaction terminals 2180 (e.g., a reader as referenced in block 1834 of FIG. 18). For simplicity, the local and/or remote computer systems or devices 2162 are referred to herein as operator computing devices 2162. The transaction terminal 2180 is configured as a secure communication interface between the personal computing system 1440 and the operator computing devices 2162 and, in particular, is configured to securely transfer various information therebetween to facilitate a seamless experience for the user (e.g., presenting the digital ID 1690, payment information, and other information to the operator computing system 1462, and the issuing access rights 1666a to the personal computing systems 1440).

Various aspects of the personal computing systems 1440, the remote operator computing system 2162, the transaction terminal 2180, interactions therebetween, and methods performed thereby are discussed in further detail below.

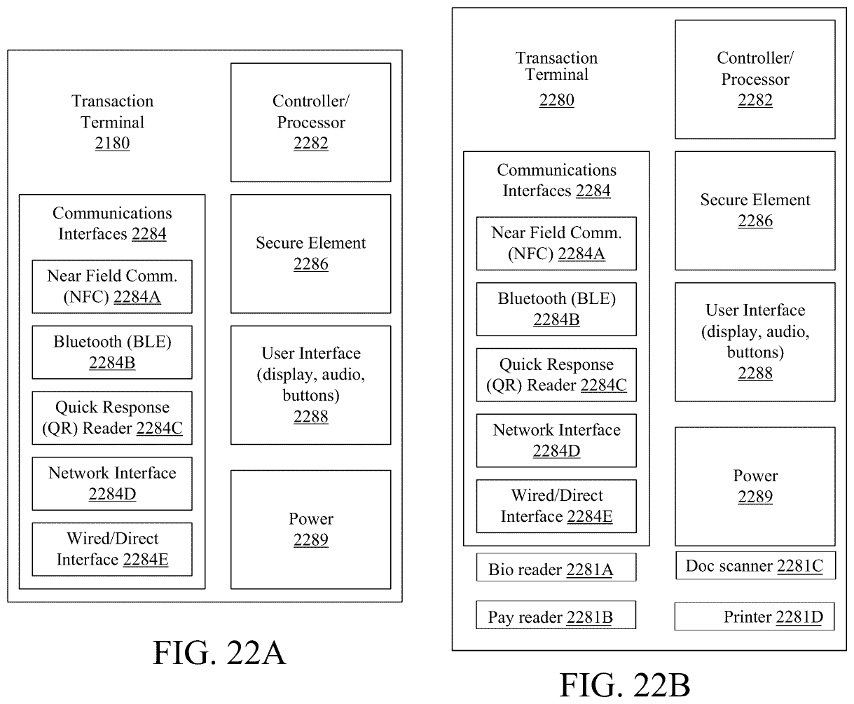

Referring to FIG. 22, the transaction terminal 2180 is a dedicated-purpose device, not a general purpose device. The transaction terminal 2180 is a point-of-service device that is configured to deliver or facilitate delivery of an electronic key to the personal computing devices of users, as well as facilitate related transactions therebetween (e.g., transfer of digital IDs, consents, payment information, other information, and requests therefor from the personal computing devices and to the operator computing devices 2162). The transactions or exchanges of information may include, but are not limited to and in some configurations or applications may not include transfer of payment information. The transaction terminal 2180 may, for example, have a physical form factor that is relatively small (e.g., less than 500 cubic centimeters), for example, being configured to rest on a table or be supported by a stand for interaction with the user. For example, the transaction terminal may be referred to as a point-of-service terminal, station, or a puck. Moreover, the transaction terminal, as a unit or components or functions thereof (e.g., communications interfaces, secure elements, etc.), may be used with or otherwise incorporated into a terminal (e.g., a kiosk or a self-service kiosk) that performs other functions, for example, associated with a person checking into an asset operator for access to physical assets thereof. For example, a kiosk 2280A may additionally include suitable hardware that is configured to perform additional functions beyond those described herein for the transaction terminal, for example, including a biometric reader 2281A, such as a camera, finger print reader, or three-dimensional scanner, to verify the identity of the user (e.g., according to the digital ID 1490), to receive inputs for selecting a physical asset (e.g., the user interface 2288 being configured as a large touch screen, sized similar to a tablet or desktop computer, that displays and receives inputs for options for a room or rental car, which may be connected to the property management system of the asset operator)), output physical key cards with access rights/credentials (e.g., including the key generator 2595 discussed subsequently), and/or to receive other forms of payment (e.g., such as a credit card reader 2281B, such as a credit card, as opposed to payment information that may be tokenized or otherwise stored by the personal computing device 1490 of the user, such as in a digital wallet), document scanners 2281C (e.g., a camera for reading physical driver licenses or passports or electronic information therefrom, such as with near-field communication), and/or printers 2281D (e.g., for printing receipts or other documentation). The kiosk may be connected to the transaction terminal in any suitable manner, for example, via wired connections (e.g., USB or ethernet). In the case of the transaction terminal being used with the kiosk, the transaction terminal 2180 still performs the functions of receiving the digital ID 1490 from the personal computing device 1440 of the user and/or providing the electronic key thereto. For example, the operator computing system 1462 may be configured as a kiosk that is in communication with (see, e.g., FIG. or includes one of the operator computing devices 2182 and the transaction terminal 2180 as a physical singular unit (e.g., contained in a common housing and/or on a common stand) and/or physically connected system, which may be in communication with further computing devices 2182 (e.g., back end servers) of the computing system 1462.

The transaction terminal includes various short-range and/or low power wireless communication hardware (e.g., short-range devices (SRD)), for example, for near field communication (NFC), Bluetooth Low Energy (BLE), quick response (QR), and/or ultra wide band (UWB), which are beneficial for direct communication with the personal computing devices of the users. The transaction terminal 2180 is further configured to perform secure communication and cryptographic functions to facilitate secure transfer of information. As referenced above, the transaction terminal 2180 is not a general purpose device, including minimal interfaces for communication to a user and receiving user inputs therefrom (e.g., does not include a large display, physical keyboard, or virtual keyboard), though may be connectable to other computing devices for servicing and technical support of updates. Upon physical presentation of the personal computing device by the user to the transaction terminal 2180 (e.g., placing within a few inches or physically contacting), and electronic connection is established and the necessary transactions (e.g., exchanges of information) are performed to ultimately deliver the access rights 1666a (e.g., the electronic key 720, access rights 1666a, or access credentials) to the device of the user. Thus, the user may need only physically present their personal computing device 1440 to the transaction terminal 2180 one time, subsequent to which all exchanges of information are performed as may be needed or desired to facilitate eventual transmission of the access rights 1666a thereto. This may require that the user interact with the personal electronic device 1440 to provide various selections (e.g., of different digital IDs 1490, different payment methods, other information) and/or to provide consents (e.g., to data transfer, data receipt, and/or legal terms and conditions). The access credentials may be transferred to the personal computing device 1490 and, in particular, to digital wallet that is native to the operating system of the personal computing device 1490 with the transferring to an intervening application of a third party and without the user or need to download or otherwise use any third party application (i.e., owned or managed by a party other than that which provisions the operating system or manufacturers or brands the personal computing system).

The transaction terminal 2180 is an electronic device that generally includes a controller 2282, communications interfaces 2284, a secure element 2286, a user interface 2288, and power electronics 2289.

The controller 2282 may be generally configured as described for the controller 222. The controller 222 is configured to manage communications protocols, execute firmware, and perform local data processing, as may be needed for the functions of the transaction terminal 2180 described herein.

The communications interfaces 2284 are configured to communicate with the personal computing devices 1440 and the operator computing devices 2162. The communications interfaces 2284, for example, include one or more of (e.g., all of) a near field communication (NFC) interface 2284a, a Bluetooth interface 2284b, a quick response (QR) reader 2284c, a network interface 2284d, and a direct wired interface 2284e.

The NFC interface 2284a is configured to exchange data with the personal computing devices 1440, including requests (from the operator computing devices 2162) and user information from the personal computing device 1440, which may include digital ID 1490, payment information, preferences, consents, access rights 1466a, other information, and requests therefor. The NFC interface 2284a is configured to operate according to any suitable communications methods, protocols, standards, or formats, such as ISO/IEC 14443, ISOISO 18013-5, and/or enhanced contactless polling.

The Bluetooth interface 2284b is configured to exchange data with the personal computing devices 1440 and/or the operator computing devices 2162. The Bluetooth interface 2284b may be configured to operate according to any suitable communications methods, protocols, standards, or formats, such as Bluetooth Low Energy (BLE), Bluetooth 5.x, customer data exchange (e.g., using Generic ATTribute (GATT) profiles), and/or standard profiles (e.g., Human Interface Device (HID) Protocol).

The QR reader 2284c is a visual scanner that is configured to read visual codes from the personal computing devices 1440. The visual codes may be output by the personal computing devices 1440, which may be configured as 1-dimensional or 2-dimensional barcodes (QR codes), for example, to transfer information and/or securely link the transaction terminal 2180 with the personal computing device 1440.

The NFC interface 2284a and the Bluetooth (BLE) interface 2284b are generally considered short-range (i.e., short distance) and/or low power devices. The transaction terminal may instead or additionally include any other current or future short-range and/or lower power communication devices, including ultrawideband devices or any other suitable devices that communicate according to any suitable protocols.

The network interface 2284d is configured to communicate with a network (e.g., the network 102) to, thereby, communicate with the operator computing devices 2162. The network interface 2284d may be configured for wireless communication (e.g., Wi-Fi and/or cellular modem) and/or wired communication (e.g., Ethernet).

The direct wired interface 2284e is configured for direct communication between another computing device and the transaction terminal 2180, for example, being configured as a Universal Serial Bus (USB) port for power and/or data transfer.

The secure element 2286 is a hardware module (e.g., processor, chip, or other component) that transfers, stores, and/or processes data in a secure manner and separate from functions performed by the controller 2282. For example, the secure element 2286 may perform various functions of the transaction terminal 2180 that involve cryptography (e.g., for verification of the digital IDs 1690 and issuance of access rights 1666a). The secure element may, for example, comply with Federal Information Processing Standards (FIPS).

The user interface 2288 is configured to interface with the user (e.g., the owner of the personal computing device 1440). The user interface 2288 may include visual aspects (e.g., display, lights), audio aspects (e.g., microphone, speaker), and/or physical aspects (e.g., touch screen, physical buttons) for providing information to and receiving inputs from the user. For example, the user interface 2288 may provide messages, instructions, and/or confirmations to the user, and may receive inputs from the user (e.g., selections, electronic connections, etc.).

The power source 2289 may, for example, be to provide alternating current (AC) power and/or direct current (DC) power (e.g., battery backup). The power source 2289 may, for example, use the direct wired interface 2284e to receive power (e.g., USB port).

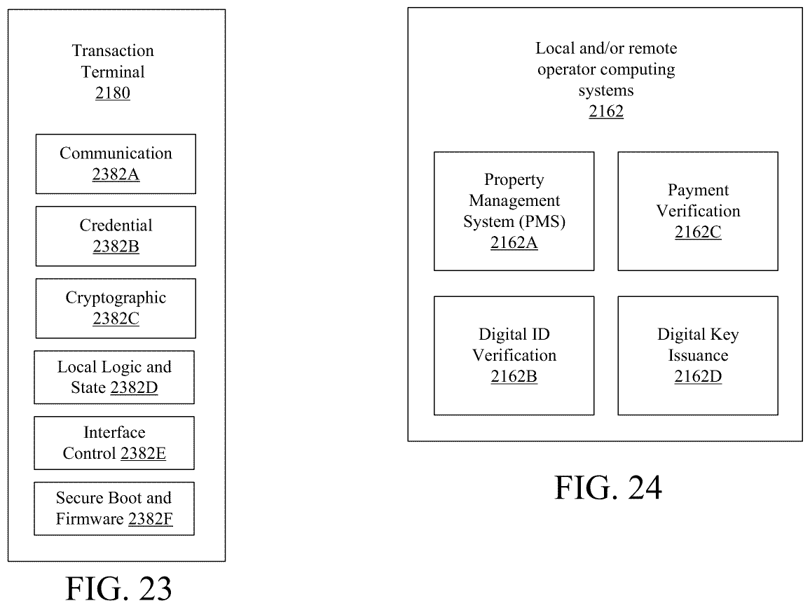

Referring to FIG. 23, the transaction terminal 2180 further includes various modules that are executed and otherwise implemented by the hardware thereof, which include a communication module 2382A, a credential module 2382B, a cryptography module 2382C, a local logic and state module 2382D, an interface module 2382E, and/or a secure boot and firmware module 2382F. The communication module is configured to manage the exchange of information with the personal computing devices 1440 and the local and/or operator computing devices 2162 via the different communications interfaces 2284 (e.g., NFC 2284a, Bluetooth 2184b, QR 2284c, network interface 2284d, and/or direct wired interface 2284e). The credential module 2382B is configured to interpret received information (e.g., digital IDs 1490) for formatting (e.g., the particular format or standard of the digital ID 1490, which may vary by the governmental authority) and other information related thereto. The cryptography module 2382C is configured to perform various cryptographic operations, for example, to store, transmit, and/or process various information in a secure manner (e.g., for digital keys, payment information, and/or digital IDs), which may include encrypting and decrypting such information with various cryptographic keys. The local logic and state module 2382d is configured to manage the specific transactions occurring with personal computing system 1440 of the user and the local and/or remote operator computing systems 1460, and/or handle local error conditions (e.g., with data transmission and/or communicating the errors and/or instructions to users). The interface control module 2382E is configured to control the user interface 2288 (e.g., to communicate various information to the user and/or receive inputs therefrom). The secure boot and firmware module 2382F is configured to ensure integrity of the transaction terminal 2180 (e.g., operability), including communicating errors and/or receiving updates (e.g., firmware and/or software).

Referring to FIG. 24, the operator computing devices 2162 includes various modules that are executed by the hardware thereof, which include a property management system (PMS) 2162A, a digital ID verification module 2162B, a payment verification module 2162C, and/or a digital key issuance module 2162D. The property management system 2162A is configured to store information related to the physical assets (e.g., hotel rooms, rental cars, offices, event venues, residential buildings, short term rental units, among others), which may include reservation information (e.g., reserving a particular physical asset to a user for a particular time period) and asset characteristics (e.g., location, size, type, features, security levels, etc.). The property management system module 2162A, in some examples include an interface for interacting with a property management system stored and/or operated by a computing system of a third party. The digital ID verification module 2162B is configured to verify the digital ID 1490 presented by the users, for example, as described previously (e.g., by using the public key of the issuer to decrypt the digital ID). The payment verification module 2162C is configured to verify the payment information provided by the user, which may include secure processing of tokenized payment information (e.g., as stored by a digital wallet of the personal computing system 1440 of the user) and/or submission of the payment information to a payment gateway (e.g., a third party system for processing and/or confirming payment credentials, such as of the financial institution or processor associated with the payment information provided). The digital key issuance module 2162D is configured to provision a digital key (e.g., the access rights 1466a) in the manners described previously for the electronic access keys 720, the access rights 1466a, or as otherwise described herein. It should be noted that various of the modules may actually be or simply be configured to interface with other systems that perform the foregoing modules (e.g., the property management system 2162A may be a computing system owned and managed by another party, which the operator computing devices 2162 communicates with).

It should be noted that while each of the property management system module 2162A, the digital ID verification module 2162B, the payment verification module 2162C and the digital key issuance module 2162D are discussed as being provided by the local and/or remote operator computing system 1460, one or more of these modules may instead or additionally be included or provided by the transaction terminal 2180 (e.g., the digital ID verification module 2162B), so as to perform more operations therewith (e.g., for security and/or networking purposes, for example, if the local and/or remote operator computing system 1460 were not provided and/or unavailable, such as with a network disconnection).

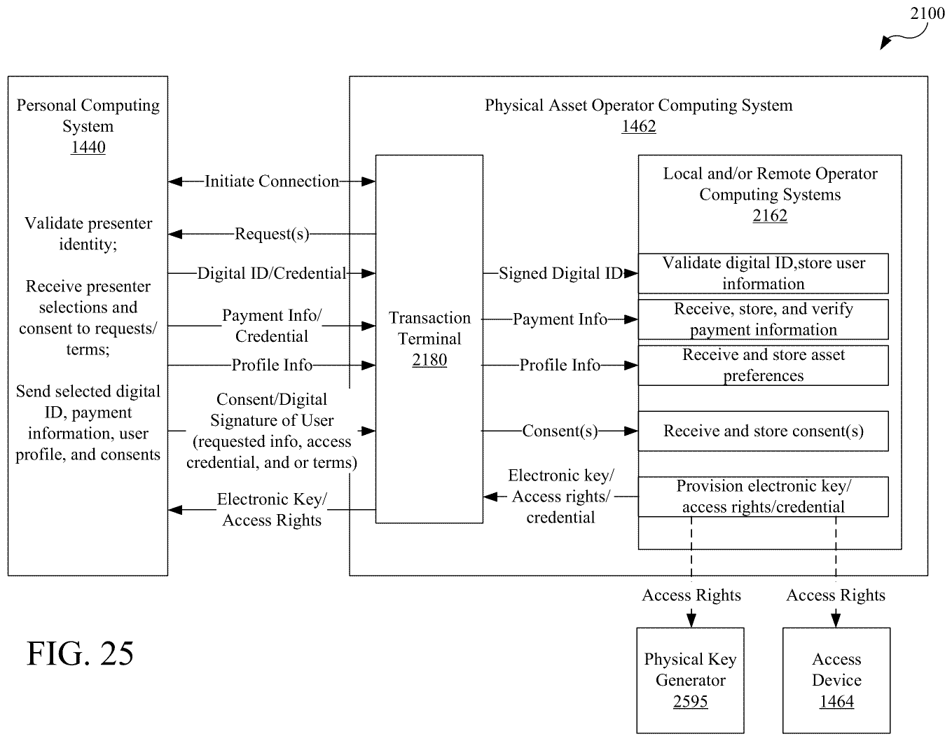

Referring to FIG. 25, the personal computing system 1440 is configured to interface with the operator computing system 1462 via the transaction terminal 2180. More particularly, the electronic key system 2100 is configured to operate to handle multiple aspects of a transaction in a manner perceived to be seamless by a user (e.g., a single tap), which includes verifying the user identify, providing and validating the digital ID of the user, providing and authorizing payment information, and issuing access rights, and which may further include providing asset preferences and providing and receiving consent of the user.

To start a transaction, the user physically presents the personal computing system 1440 to the transaction terminal 2180 to initiate an electronic connection therewith. For example, the user moves the personal computing device 1440 within close proximity (e.g., within two inches, one inches, or physically contact, so as to initiate an electronic connection with the transaction terminal via short range communications methodologies, such as NFC, BLE, or UWB). The personal computing system 1440 and the transaction terminal exchange signals (e.g., a handshake) to establish a secure electronic communication therebetween (e.g., via the NFC interface 2184a and/or the Bluetooth interface 2184b) by which digital credentials (e.g., the digital IDs 1490 and/or payment information) and access rights (e.g., digital keys) are transmitted therebetween. The transaction may be completed (i.e., the electronic key is delivered to the personal computing device 1490) without the user needing to again physically present the personal computing device 1490 to the transaction terminal 2180 (i.e., single presentation).

The transaction terminal 2180 then sends one or more requests for two or more types of credentials or information from the personal computing system 1440. The requests include a request for the digital ID 1490 (or selected information from the digital ID 1490) and another credential (e.g., payment information), and may further include one or more consents, and/or asset preference information (e.g., of the user profile 1495). In a preferred embodiment, the requests are for the digital ID 1490, payment information, and consent. One or more of the requests may be sent by the transaction terminal 2180 with or without intermediate data transfer or instructions between the transaction terminal 2180 and the operator computing devices 2162 (i.e., after initiation by the personal computing device 1440 and before sending of the requests). The personal computing system 1440 includes a secure element (e.g., hardware element configured to store sensitive information in a secure element) and/or a digital wallet (e.g., according to standards of various phone manufacturers, governmental entities, financial institutions, or other standard setting organization) that stores the digital ID 1490, payment information, and/or digital keys (e.g., electronic key 720 and/or access rights 1466a).

The digital ID 1490 requested may be as described above (e.g., being issued by a governmental entity), or may include selective information from the digital ID 1490. The payment information requested may, for example, be tokenized payment information (e.g., generated for a particular payment method on a particular device). Consent may be requested by the transaction terminal 2180 and given by the user for one or more of three or more reasons. First, the consent requested may, for example, be to authorize transfer of the requested information (e.g., the user providing consent to sending of the credentials, including the digital ID 1490 or information contained therein and the payment information). Second, consent may be to terms and/or conditions associated with the asset (e.g., contractual terms and conditions related to a stay at a hotel or a rental car). Third, consent may be given by the user for transfer of information (e.g., the electronic key 720 or other access credential) to the personal computing device 1440 of the user. Fourth, the preference information requested may, for example, be the user profile 1495 or information thereof and consent given for the operator computing system 1462 to receive, use, and/or store the preference information. Separate consent may be given for each of the requests. The consent may instead or additionally provided by the digital signature of the user (e.g., of the personal computing device 1440) being applied to the credentials being sent to the transaction terminal 2180. The consents may be provided by the user to the personal computing device 1440, for example, by validating their identity biometrically and/or by pressing one or more buttons affirming consent for all requested consents or each requested consent individually.

The personal computing system 1440 validates the identity of the user biometrically, as described previously (e.g., see discussion regarding the validating 1832a). The personal computing system 1440 may validate the identity of the user prior to or after receiving one or more (e.g., all of) the requests. The personal computing system 1440 may, for example, read biometric data of the person (e.g., fingerprint and/or facial shape) that is compared to that stored as part of the digital ID 1490. Alternatively, the transaction terminal 2180 may validate the identity of the user biometrically by including similar hardware capable of reading biometric data of the user (e.g., camera, LIDAR, and/or fingerprint reader) and comparing it to that of the digital ID 1490.

The personal computing system 1440 receives the requests from the transaction terminal 2180, receives selections and/or consent of the user, and then transmits the requested and selected information to the transaction terminal 2180. Consent may be given, for example, by the user allowing validation of their identity (i.e., by providing biometric information) or other positive indication of authorization (e.g., button press). The user may be prompted to select the particular form of information requested, for example, selecting one or another of the digital IDs 1490 that may be stored thereon (e.g., mobile driver license or mobile passport) and/or one or another of different payment methods (e.g., different credit cards). The user may also consent to default selections of such requested information. The personal computing system 1440 then sends the requested and selected information the transaction terminal 2180, which may constitute sending consent or specific consent information may also be sent. Each of the digital ID 1490 (or selected information thereof) and the payment information may be considered a credential. In sending the credentials to the transaction terminal 2180, the personal computing system 1440 may digitally sign each subset of information or the entire group of information with the private key thereof (e.g., as described previously) and, thereby, be considered user-signed.

It should be noted that the requests and/or information may be sent sequentially or in batches. For example, the transaction terminal 2180 and the personal computing system 1440 may request and send, respectively, the digital ID 1490, the payment information, and the consent in an alternating and sequential fashion. This may allow the operator computing devices 2162 to receive and process each piece of information before requesting the next piece of information (e.g., validating the digital ID 1490 before requesting payment information). Alternatively, the transaction terminal 2180 and the personal computing system 1440 may request and send, respectively, the digital ID 1490, the payment information, and the consent in groups (e.g., batched manner). In either scenario, and in different variations thereof, the series of exchanges of requests and information may be perceived by the user as a single transaction (e.g., one-time presentation and interaction with the personal computing system 1440).

The transaction terminal 2180 sends the requested and received information (e.g., the credentials and consents) to the operator computing devices 2162. As referenced above, the transaction terminal 2180 may send the requested and received information to the local and/or the operator computing devices 2162 singularly or in groups (e.g., batched manner).

The transaction terminal 2180 or the operator computing devices 2162 may validate the credentials sent by the personal computing system 1440 by with the public key of the user.

The operator computing devices 2162 next validates the digital ID 1690 of the user, retrieves information about the associated physical asset (e.g., reservation and/or availability), validates payment information, and then generates and sends the access rights 1666a (e.g., the electronic key 720) to the transaction terminal or, alternatively, to the access device 1464. The validating of the digital ID 1690, retrieving of physical asset information, and payment authorization may be performed synchronously (i.e., at the same time) or asynchronously (e.g., in a step-wise manner). The generation and sending of the access rights 1666a (e.g., the digital key) is performed upon successful completion of the prior steps.

The validating of the digital ID 1490 is performed as described previously e.g., as described with respect to the validating 1836) by validating the digital signature of the digital ID 1490 with the public key of the ID issuer. If the digital ID 1490 is not validated, the operator computing devices 2162 may cause the transaction terminal 2180 to output a notification that the digital ID 1490 could not be validated and/or send a request to the personal computing device 1440 for the user to select another digital ID 1490 (e.g., a mobile passport instead of the mobile driver license originally selected and sent).

The validating of the payment information is performed, for example, by sending the payment information to the payment gateway, which then validates the payment information, and/or by processing a payment therewith. If the payment information is not validated, the operator computing devices 2162 may cause the transaction terminal 2180 to output a notification that the payment information could not be validated and/or send a request to the personal computing device 1440 for the user to select other payment information (e.g., another credit card).

The retrieving of the physical asset information includes retrieving information from a property management system associate with the physical asset, such as retrieving a stored reservation according to the identity of the user (e.g., name of the user or UUID, as discussed with respect to FIG. 20) and/or identifying physical assets available to the user (e.g., according to the user profile 1495).

Upon receipt of any necessary consents and successfully validating the digital ID 1490, validating the payment information, and identifying an available physical asset, the operator computing devices 2162 generates the access rights 1466a.

The access rights 1466a are delivered to the personal computing device 1440 of the user in one of several different manners. In a preferred example, the transaction terminal 2180 receives and sends the access rights 1666a to the personal computing device 1440 directly into the digital wallet, which may also store the digital ID 1490 of the user and/or the payment information of the user. The digital wallet is, for example, a native application pursuant to the operating system of the personal computing system (e.g., the Apple Wallet within the iOS operating system for Apple-branded mobile products, or the Google Wallet within the Android operating system for various other brands of mobile devices). The transaction terminal 2180 may be configured to work with multiple different digital wallets having different configurations and/or protocols (i.e., of different manufacturers, developers, such as both Apple and Google), so as to work the personal computing devices of different users and of different manufacturers and/or operating systems. In transmitting the access rights 1666a directly to the digital wallet, the access rights 1666a are transferred to the digital wallet without first transferring through another application by a third party (provided by other than the operating system provider) or the need for the personal computing system to download and/or operate another application of another vendor. The access rights may be transferred to and stored by the personal computing device 1490 (e.g., the digital wallet) without requiring downloading and operating another application with the personal computing device 1490 subsequent to physically presenting the personal computing device 1490 to the transaction terminal 2180 and/or prior thereto. The digital wallet may, for example, store the access rights 1666a within a secure element of the personal computing device of the user. The access rights 1666a (e.g., electronic key or access credential) may, thus, be immediately usable by the user via the personal computing device to gain access to the physical space associated with the access rights 1666a. In another example, the operator computing system 2162 stores the access rights 1466a on a network device, and the transaction terminal 2180 sends a link (e.g., a URL) to the personal computing device 1440 that then follows the link to download the access rights 1466a to the digital wallet. In yet another example, the personal computing device 1440 includes an additional module that is configured to receive the access rights 1466a directly from the transaction terminal 2180 (e.g., being sent via NFC, Bluetooth, or ultrawide band) and then transfer to the access rights 1466a to the digital wallet that may also store the digital ID 1490 and/or the payment information. In this manner, the access rights 1466a are transferred from the transaction terminal 2180 directly to the personal computing device 1440 of the user but indirectly to the digital wallet thereon.

The transaction terminal 2180, for example upon receiving confirmation from the personal computing system 1440, may indicate that the transaction was successful and/or complete and/purge all information related to the user, for example, purging all data received from the personal computing system 1440 and/or operator computing devices 2162 pertaining to the user.

The operator computing devices 2162 may be further configured to be in communication with a physical key generator 2595 (e.g., a key car generator) that is configured to receive and store the access rights 1466a for use with the access device 1464 (e.g., writing to an NFC device that stores and may be read by the access device 1464.

The personal mobile computing device 1440 is configured to then present the access rights 1466a to the access device 1464 in the manners described previously (e.g., for the electronic key 720 and/or the access rights 1466a).

The storage and transmission of data between the personal computing device 1440, the transaction terminal 2180, and the local and/or remote operator computing systems 1460 may be performed according to various standards, protocols, and/or for security purposes. The request and/or sending of the digital ID 1490 or selected information thereof may be performed according to any suitable protocol or standard, such as Mobile Driving Licenses (“mDLs”) and mobile document (“mdoc”) formats, such as for ISO 18013-5 and/or Open ID Connect for Verifiable Presentations (OIDC4VP). The request and/or sending of the payment information may be performed according to any suitable protocol or standard, such as EMVCo specifications for contactless payments. The personal computing device 1440 and the transaction terminal 2180 may communicate in a secure manner, for example, using encryption via session keys established through securing pairing (e.g., handshake) protocols. The transaction terminal 2180 and the local and/or remote operating computing systems 1460 may communicate in a secure manner via HTTPS/TLS with strong ciphers. The local and/or remote operating computing systems 1460 may communicate in a secure manner with other systems (e.g., financial institutions, property management system) via secure application programming interfaces (e.g., APIs). Any information stored on the transaction device 2180 (e.g., when stored temporarily thereby) and/or the local and/or remote operating computing system 1460 may be encrypted.

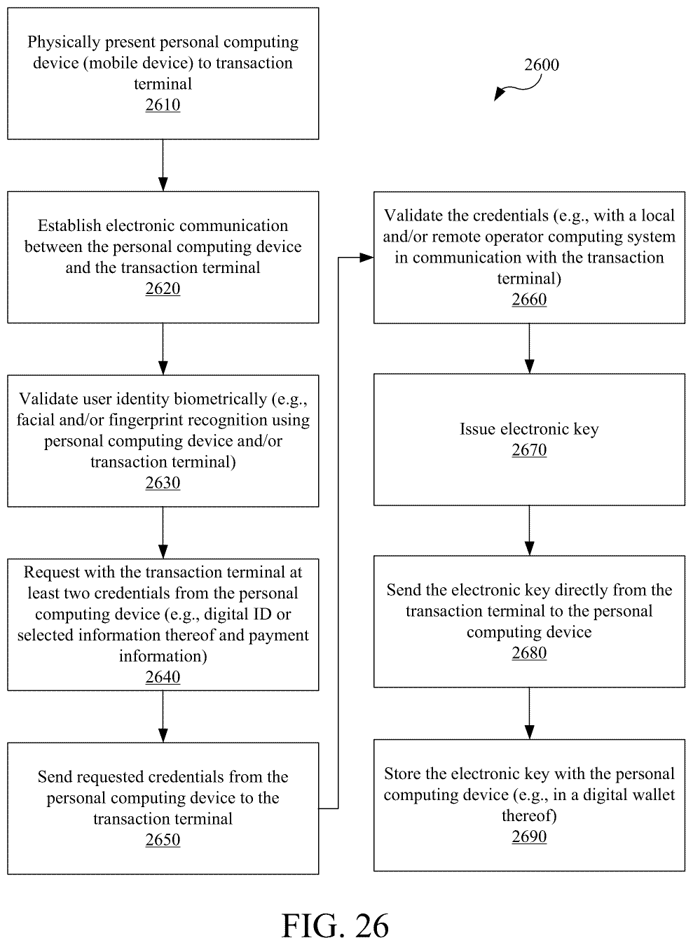

Referring to FIG. 26, a method 2600 performed for issuing and/or using an electronic key. The method 2600 generally includes physically presenting 2610 a personal computing device and a transaction terminal, establishing electronic communication 2620 the personal computing device and the transaction terminal, validating 2630 the identity of the user, requesting 2640 with the transaction terminal at least two credentials from the personal computing device, sending 2650 the requested and selected credentials directly from the personal computing device to the transaction terminal, validating 2660 the at least two credentials, issuing 2670 an electronic key, sending 2680 the electronic key directly from the transaction terminal to the personal computing device, and storing 2690 the electronic key with the personal computing device. The method 2600 is performed while the personal computing device of the user remains in close proximity to the transaction terminal sufficient for transmission of information directly therebetween (e.g., via NFC and/or Bluetooth).

The physical presenting 2610 includes a user moving its personal computing device (e.g., a mobile device or phone, such as the personal computing device 1440) into close proximity with a transaction terminal (e.g., the transaction terminal 2180). The physically presenting 2610 may also be referred to as being physically presented 2610, as the asset operator computing system 2100 is presented with the personal computing device).

The establishing electronic communication 2620 includes, in response to the physical presenting 2610, exchanging data therebetween to further exchange requests and information therebetween. The electronic communication 2620 may be established and/or performed via the appropriate hardware of the respective devices, such as communications interfaces for near field communication, Bluetooth, and/or quick response codes, and according to various standards and/or protocols (e.g., for a secured connection).

The validating 2630 of the user identify includes reading live biometric information of the user and comparing that to stored information. For example, the personal computing device may include a camera, LIDAR, or fingerprint reader that reads biometric data of the user, which is then compared to stored biometric data (e.g., as contained in a digital ID, such as the digital ID 1490) of the user. As an alternative to the validating 2630 the identity of the user being performed by the personal computing device, the transaction terminal may include suitable hardware (e.g., camera, LIDAR, and/or fingerprint reader) for reading the live biometric information of the user for comparison to stored biometric information received thereby (e.g., that stored in the digital ID that is sent to the transaction terminal).

The requesting 2640 of the credentials is performed by the transaction terminal sending a request to the personal computing device via the electronic communication established therebetween (e.g., via NFC and/or Bluetooth). The requests may be default requests programmed to the transaction terminal to be made with each of the personal computing devices, or may be sent as instructed by the local and/or remote operator computing systems. The credential requests include a first request for the digital ID of the user of the personal computing device or a subset of information contained therein (e.g., name or other information sufficient for subsequent operations, such as retrieving or making reservations of a physical asset) and a second request for another credential, such as payment information. The requests may further includes requests for preference information of the user (e.g., of the profile 1495) and/or for consents of the user (e.g., consenting to transmission of information (e.g., credentials and/or profile information), consent to terms and conditions of the operator, and/or consent to receipt of access credentials via one or more methodologies). The requests may be made according to suitable standards and/or protocols (e.g., for digital IDs and/or payment information).

The sending 2650 of the requested credentials, information, and consents is performed by the personal computing device of the user sending the requested credentials via the electronic communication established therebetween (e.g., via NFC and/or Bluetooth). The sending 2650 may further include user selection of which of the credentials stored by the personal computing device (e.g., in a digital wallet thereof) to be sent, for example, the user selecting via a touch screen which of multiple digital IDs to send or from which a subset of information is sent (e.g., a mobile driver license or mobile passport) and/or which form of payment (e.g., one of a number of different forms of payments from different financial institutions). The digital ID or subset of information was digitally signed by the issuer (e.g., the governmental ID). The payment information may be tokenized.

The sending 2650 further includes receiving user consents to the sending of the credentials or other information pertaining to the user to the transaction terminal and/or to terms and conditions associate with a physical asset (e.g., renting a hotel room or car). Consent may be simply the information being sent and/or by information being sent that otherwise indicates consent given by the user.

The sending 2650 may include sending the credentials, information, and consent as separate packages of information or as a combined package.

The sending 2650 may further include the information being digitally signed by the personal computing device (e.g., hashing the package(s) of information) and encrypting the hash with a private key of the user or the personal computing device of the user, in the manners described previously or otherwise known.

The validating 2660 of the credentials is performed with the local and/or remote operator computing system using appropriate modules (e.g., the digital ID verification module 2162B and the payment verification module 2162C). The transaction terminal receives from the personal computing system and then sends to the remote and/or local operator computing system the credentials, other information, and/or consents of the user. The local and/or remote operator computing system validates the digital ID or subset of information thereof using the public of the issuer of the digital ID in the manners described previously. The local and/or remote operator computing system further validates the payment information, for example, by processing a payment and/or confirming the payment information with the financial institution or other processor.

The validating 2660 may further include validating the digital signature of the user (or personal computing device) with the transaction device (e.g., before sending the credentials, other information, and/or consents to the remote and/or local computing systems) or with the remote and/or local computing system (e.g., using the public key of the user and/or a hashing function).

If either of the credentials are not validated, the operator computing device causes the transaction device to request another credential (e.g., digital ID and/or payment information) from the user (e.g., re-performing steps 2640, 2650, 2660 one or more other credentials).

The issuing 2670 of the electronic key is performed by the local and/or remote computing system. The local and/or remote computing system retrieves information from the property management system (e.g., using the property management system module 2162A) to identify a reservation for the user for a particular physical asset (e.g., searching by the name of the digital ID), or by identifying an available physical asset according to the other information (e.g., preferences in the user profile 1495). Upon identifying the physical asset, the local and/or remote operator computing system issues an electronic key with access rights (e.g., the access rights 1490) to the user for that physical asset. The electronic key may be provisioned in the manners describe previously, for example, with the electronic access key 720 that is digitally signed by the operator (e.g., encrypting a hash of the electronic access key with a private key of the asset operator).

The sending 2680 of the electronic key (e.g., the access credential) is performed with the transaction terminal directly to the personal computing device, for example, with NFC and/or Bluetooth. Instead or additionally, the electronic key may be sent via an intermediate network. However, sending the electronic key directly from the transaction terminal to the personal computing device is advantageous in case any network is unavailable to either the personal computing device (e.g., lack of cellular connectivity, such as when a traveler enters a new country) and/or connectivity otherwise being unavailable for the personal computing device and/or the local and/or remote computing system. Upon completing the sending 2680, the transaction terminal may further provide confirmation of the transaction being completed (e.g., with the user interface thereof outputting a visual or audio message, or otherwise providing a positive indication, such as a green light). In another example, the operator computing system stores the access credential on a network device the, and transaction terminal sends a link (e.g., a URL) to the personal computing device that then follows the link to download the access rights to the digital wallet thereof. In yet another example, the personal computing device includes an additional module that is configured to receive the access rights directly from the transaction terminal (e.g., being sent via NFC, Bluetooth, or ultrawide band) and then transfer to the access rights to the digital wallet that may also store the digital ID and/or the payment information. In this manner, the access rights 1466a are transferred from the transaction terminal 2180 directly to the personal computing device 1440 of the user but indirectly to the digital wallet thereon. The sending 2680 of the electronic key may be performed with the personal computing device being presented to the transaction terminal only once (i.e., the presenting 2610).

The storing 2690 of the electronic key is performed by the personal computing device, for example, in a digital wallet that may also store the digital ID and/or payment information of the user. The electronic key is received by the personal computing device and stored thereby. The electronic key may then be presented by a user with the personal computing device to an access device to be permitted access to the physical asset associated therewith (e.g., as described with respect to FIGS. 1-13). The user may then use the personal computing device to present the access credential (e.g., the electronic key to the access device, which validates the access credential with the public key of the operator and, if both valid and access rights provided to the user for the current time, grants access of the physical space associated therewith to the user (see, e.g., the previous methods described herein). As referenced above, the personal computing device may not need to download and/or operate any other application in order to receive and/or store the electronic key after the physical presentation 2610 and/or any time prior thereto.

It should be noted that various aspects of the method may be performed without others. For example, in some embodiments, the requests, consents, and/or validations are contemplated as not being performed between the presenting 2610 of the personal computing device and the sending 2680 of the electronic key.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An electronic key system for providing an electronic key for a physical space comprising:
a transaction terminal; and
an operator computing system in communication with the transaction terminal;
wherein the transaction terminal is configured to communicate with a personal computing device of a user to which access rights are to be issued;
wherein the transaction terminal sends requests to the personal computing device for information from a digital identification of a user and for consent of the user to send an access credential thereto; and
wherein the operator computing system validates the information of the digital identification with a public key of the issuer of the digital identification.

2. The system of claim 1, wherein the transaction terminal further sends a request to the personal computing device for payment information, and the operator computing system validates the payment information via a payment gateway.

3. The system of claim 2, wherein if the operator computing system does not validate the information of the digital identification, the transaction terminal sends a further request to the personal computing system for information from another digital identification of the user, and if the operator computing system does not validate the payment information, the transaction terminal sends a further request to the personal computing system for other payment information.

4. The system of claim 1, wherein the consent is for the access credential to be sent directly from the transaction terminal to a digital wallet of an operating system of the personal computing system.

5. The system of claim 4, wherein the transaction terminal sends the access credential directly to the digital wallet without requiring a further application be downloaded and operated by the personal computing device.

6. The system of claim 4, wherein the transaction terminal is configured to communicate with another personal computing device and send another access credential to another digital wallet of another operating system of the other personal computing device, the other digital wallet having a different configuration than the digital wallet.

7. The system of claim 1, wherein the consent is for one of the access credential to be sent from the transaction terminal to another module of the personal computing system and subsequently to the digital wallet, or for the personal computing system to retrieve the access credential from the operator computing system into the digital wallet.

8. A system of claim 1, wherein the operator computing system is configured to validate the information received from the personal computing device via the transaction terminal with a public key of the user.

9. A transaction terminal of an electronic key system for physical assets comprising:
a controller; and
a communications interface configured to communicate with a one or more short-range wireless communication devices;
wherein the transaction terminal is configured to send, with the one or more short-range wireless communication devices, an electronic key to the personal computing system of a user, the electronic key being digitally signed by an issuer associated with the transaction terminal and to provide access to a physical asset.

10. The transaction terminal of claim 9, wherein the transaction terminal is configured to send the electronic key to a digital wallet of the personal computing system of the user.

11. The transaction terminal of claim 10, wherein the transaction terminal is configured to send the electronic key directly to the digital wallet of the personal computing system, the digital wallet being native to an operating system of the personal.

12. The transaction terminal of claim 9, wherein the transaction terminal is configured to send, with the communications interface, a request for consent of the user for sending the electronic key from the transaction terminal to the personal computing system; and
wherein the transaction terminal is configured to receive, via the communications interface, consent from the user for receiving the electronic key.

13. The transaction terminal of claim 9, wherein the transaction terminal is configured to send requests to the personal computing system for information of a digital identification of the user;
wherein the transaction terminal is configured to receive from the information of the digital identification from personal computing device and send the information of the digital identification of the user to an asset operator computing system for validation with a public key of the issuer of the digital identification.

14. The transaction terminal of claim 13, wherein if the asset operator computing system does not validate the information of the digital identification, the transaction terminal sends a further request to the personal computing device for information from another digital identification.

15. The transaction terminal of claim 13, wherein the transaction terminal does not send the electronic key to the personal computing device of the information of the digital identification is not verified by the asset operator computing system.

16. A transaction terminal of claim 13, wherein the transaction terminal further sends a request to the personal computing device for financial information, and is configured to receive the financial information from the personal computing device and send the financial information to the asset operator computing system for validation thereby.

17. A method for providing an electronic key for a physical space includes:
receiving a physical presentation by a user of a personal computing device to a transaction terminal of an operator computing system of an operator of a physical asset;
verifying, with the personal computing device, the identity of the user with biometric information;
receiving, with the transaction terminal from the personal computing device, identification information of a digital identification of a user and another credential of the user;
validating, with the operator computing system, the identification information and the other credential; and
sending, upon validating the identification information and the other credential, an electronic key with the transaction terminal directly to the personal computing device of the user, the electronic key being presentable by the user with the personal computing device to gain access to the physical asset.

18. The method of claim 17, wherein the method includes receiving only one physical presentation of the personal computing device to the transaction terminal.

19. The method of claim 17, wherein the personal computing device stores the digital identification, the other credential that is payment information by which the operator receives payment, or both with a digital wallet, and the personal computing devices further stores the electronic key with the digital wallet.

20. The method of claim 19, wherein the operator computing system validates the identification information with a public key of an issuer of the digital identification, and validates the payment information by sending the payment information to a processor of the payment information.

21. The method of claim 17, wherein the personal computing device and the transaction terminal communicate the identification information, the other credential, and the electronic key directly via near field communication or Bluetooth.

22. The method of claim 17, wherein the identification information and the other credential are digitally signed by the personal computing device with a private key of the user;
wherein the method further comprises validating, with the transaction terminal or the operator computing system, the digital signature of the identification information and the other credential with a public key of the user.

23. The method of claim 17, further comprising receiving, with the personal computing device of the user, and storing the electronic key in a digital wallet of the personal computing device.

24. The method of claim 23, wherein the receiving and storing of the electronic key are performed without the personal computing device downloading and operating another application for receiving and storing the electronic key prior to or after the physical presentation of the personal computing device to the transaction terminal.

25. (canceled)
